(19) United States
(12) Patent Application Publication
(10) Pub. No.: US 2025/0110495 A1
(43) Pub. Date: Apr. 3, 2025

(54) BUILDING AUTOMATION SYSTEM WITH INTEGRATED VIDEO FEED

(71) Applicant: Tyco Fire & Security GmbH, Neuhausen am Rheinfall (CH)

(72) Inventors: Sourabh Taranath Joshi, Wagholi (IN); Joseph S. Stangarone, Milwaukee, WI (US); Koel Biswas, Dumdum (IN); Tushar V. Kshirsagar, Allentown, PA (US)

(21) Appl. No.: 18/895,903

(22) Filed: Sep. 25, 2024

(30) Foreign Application Priority Data
Sep. 28, 2023 (IN) 202321065370

(51) Int. Cl. G05B 23/02

(52) U.S. Cl. CPC G05B 23/0275; G05B 23/0216

(57) ABSTRACT

A Building Automation System (BAS) can include one or more memory devices storing instructions thereon. The instructions can, when executed by one or more processors, cause the one or more processors to detect an occurrence of an event associated with building equipment of a building and determine a time of the occurrence of the event, execute an automated video gathering process, perform a diagnostic process using video data to determine a potential cause of the occurrence of the event, and initiate an automated resolution to address the potential cause of the occurrence of the event.

### CROSS-REFERENCE TO RELATED PATENT APPLICATIONS

This application claims the benefit of and priority to Indian Provisional Patent Application No. 202321065370, filed Sep. 28, 2023, the entirety of which is incorporated by reference herein.

### BACKGROUND

The present disclosure relates generally to a building automation system (BAS) and more particularly to a BAS configured to integrate BAS data with a building information model (BIM).

A BIM is a representation of the physical and/or functional characteristics of a building. A BIM may represent structural characteristics of the building (e.g., walls, floors, ceilings, doors, windows, etc.) as well as the systems or components contained within the building (e.g., lighting components, electrical systems, mechanical systems, HVAC components, furniture, plumbing systems or fixtures, etc.). In some embodiments, a BIM is a 3D graphical model of the building. A BIM may be created using computer modeling software or other computer-aided design (CAD) tools and may be used by any of a plurality of entities that provide building-related services.

A BAS is, in general, a system of devices configured to control, monitor, and/or manage equipment in or around a building or building area. A BAS can include, for example, a HVAC system, a security system, a lighting system, a fire alerting system, any other system that is capable of managing building functions or devices, or any combination thereof. Some BASs provide graphical user interfaces that allow a user to interact with components of the BAS. Generating graphics for the graphical user interfaces can be time consuming and often results in low quality graphics that do not adequately represent the building equipment. It would be desirable to use the graphics and modeling provided by a BIM as part of the BAS interface. However, it can be difficult and challenging to integrate BAS points with a BIM.

### SUMMARY

At least one embodiment relates to a system. The system can include one or more memory devices. The one or more memory devices can store instructions. The instructions can, when executed by one or more processors, cause the one or more processors to detect a fault condition for building equipment. The instructions can also cause the one or more processors to identify, using location information associated with the building equipment, a video device located to view the building equipment. The instructions can also cause the one or more processors to determine, using information describing the fault condition, a point in time at which the fault condition occurred. The instructions can also cause the one or more processors to determine a time segment containing the point in time. The instructions can also cause the one or more processors to retrieve, responsive to determination of the time segment, video data captured by the video device during the time segment. The instructions can also cause the one or more processors to display, via a display device, a user interface including the video data captured by the video device during the time segment.

In some embodiments, the user interface can include a graphical representation of a building that includes the building equipment, and an alert to indicate detection of the fault condition. The alert can include a selectable element, and the user interface can be displayed responsive to selection of the selectable element.

In some embodiments, the user interface can include a second selectable element to adjust the time segment to one or more second time segments.

In some embodiments, identifying the video device located to view the building equipment can include retrieving, from a Building Information Model (BIM), the information associated with building equipment. The BIM can indicate the location the building equipment and the presence of a plurality of video devices. The plurality of video devices can include the video device. In some embodiments, identifying the video device to view the building equipment can include identifying the video device from the plurality of video devices responsive to determining, based on the BIM, that the video device is within a predetermined threshold of the building equipment.

In some embodiments, updating the user interface to display the data captured by the video device can include presenting a video feed captured by the video device.

In some embodiments, the video feed captured by the video device can include at least one of a live stream of a video output captured by the video device or a recording of a video output corresponding to the time segment.

In some embodiments, the instructions can cause the one or more processors to detect the fault condition responsive to one or more values of timeseries data exceeding a predetermined value.

At least one embodiment relates to a Building Automation System (BAS). The system can include one or more memory devices. The one or more memory devices can store instructions. The instructions can, when executed by one or more processors, cause the one or more processors to detect an occurrence of an event associated with building equipment of a building and determine a time of the occurrence of the event. The instructions can also cause the one or more processors to execute an automated video gathering process in response to detecting the occurrence of the event. The automated video gathering process can include identifying a video device associated with the building equipment based on a building model of the building. The automated video gather process can also include retrieving video data captured by the video device during a time segment comprising the time of the occurrence of the event. The instructions can also cause the one or more processors to perform a diagnostic process using the video data to determine a potential cause of the occurrence of the event. The instructions can also cause the one or more processors to initiate an automated resolution to address the potential cause of the occurrence of the event.

In some embodiments, the instructions also cause the one or more processors to generate a graphical user interface comprising a graphical representation of the building including the building equipment and the video device. The instructions can also cause the one or more processers to present the video data via the graphical user interface responsive to selection of the video device in the graphical representation of the building.

In some embodiments, the automated resolution comprises an adjustment of an operation of the building equipment, the adjustment being based on the potential cause of the occurrence of the event.

In some embodiments, the instructions cause the one or more processors to provide a recommendation, via a graphical user interface, to address the potential cause of the occurrence of the event.

In some embodiments, the building model includes a Building Information Model (BIM) of the building. The BIM may indicate a location of the building equipment and a location of the video device. The instructions may cause the one or more processors to determine, based on the BIM, that the video device is positioned to view the building equipment. The instructions may also cause the one or more processors to identify the video device as being associated with the building equipment responsive to determining that the video device is positioned to view the building equipment.

In some embodiments the instructions may cause the one or more processors to display, via a graphical user interface, a standard operating procedure (SOP), the SOP including one or more predetermined actions executable to address the potential cause of the occurrence of the event.

In some embodiments, the video data is sourced from at least one of a live stream of a video output captured by the video device or a recording of a video output corresponding to the time.

In some embodiments, the instructions cause the one or more processors to determine a priority level associated with the occurrence of the event. The instructions may also cause the one or more processors to display the occurrence of the event and the priority level via a graphical user interface.

In some embodiments, identifying the video device associated with the building equipment includes determining, based on a Building Information Model (BIM) of the building, a room of the building in which the building equipment is located. Identifying the video device associated with the building may also include determining, based on the BIM, that the video device is located in the room of the building. Identifying the video device associated with the building may also include identifying the video device as being associated with the building equipment responsive to determining that the video device is located in the room of the building.

In some embodiments, identifying the video device associated with the building equipment may include determining, based on a digital twin of the building, a location of the building in which the building equipment is located. Identifying the video device may also include determining, based on the digital twin, that the video device is (1) positioned within a predetermined threshold distance from the location of the building and (2) positioned to view the building equipment. Identifying the video device may also include identifying the video device as being associated with the building equipment.

At least one embodiment relates to a method. The method may include detecting, by one or more processors of a Building Automation System (BAS), an occurrence of an event associated with building equipment of a building and determine a time of the occurrence of the event. The method may also include executing, by the one or more processors, an automated video gathering process. The automated video gathering process may include identifying a video device associated with the building equipment based on a building model of the building. The automated video gathering process may also include retrieving video data captured by the video device during a time segment comprising the time of the occurrence of the event. The method may also include performing, by the one or more processors, a diagnostic process using the video data to determine a potential cause of the occurrence of the event. The method may also include initiating, by the one or more processors, an automated resolution to address the potential cause of the occurrence of the event.

In some embodiments, the method may include generating, by the one or more processors, a graphical user interface comprising a graphical representation of the building including the building equipment and the video device. The method may also include presenting, the video data via the graphical user interface responsive to selection of the video device in the graphical representation of the building.

In some embodiments, the building model may include a Building Information Model (BIM) of the building, the BIM indicating a location of the building equipment and a location of the video device.

In some embodiments, the method may include determining, based on the BIM, that the video device is positioned to view the building equipment. The method may also include identifying the video device as being associated with the building equipment responsive to determining that the video device is positioned to view the building equipment.

In some embodiments, identifying the video device associated with the building equipment may include determining, based on a Building Information Model (BIM) of the building, a room of the building in which the building equipment is located. Identifying the video device may also include determining, based on the BIM, that the video device is located in the room of the building. Identifying the video device may also include identifying the video device as being associated with the building equipment responsive to determining that the video device is located in the room of the building.

In some embodiments, the method may include displaying, via a graphical user interface, a standard operating procedure (SOP), the SOP including one or more predetermined actions that can be taken to address the potential cause of the occurrence of the event.

In some embodiments, the method may include providing a recommendation, via a graphical user interface, to address the potential cause of the occurrence of the event.

At least one embodiment relates to one or more non-transitory storage media. The one or more non-transitory storage media may store instructions. The instructions, when executed by one or more processors, may cause the one or more processors to perform operations including detecting an occurrence of an event associated with building equipment of a building and determine a time of the occurrence of the event. The instructions may also cause the one or more processors to perform operations including executing an automated video gathering process. The automated video gathering process may include identifying a video device associated with the building equipment based on a building model of the building. The automated video gathering process may also include retrieving video data captured by the video device during a time segment comprising the time of the occurrence of the event. The instructions, when executed by one or more processors, may also cause the one or more processors to perform operations including performing a diagnostic process using the video data to determine a potential cause of the occurrence of the event. The instructions, when executed by one or more processors, may also cause the one or more processors to perform operations including initiating an automated resolution to address the potential cause of the occurrence of the event.

The instructions, when executed by one or more processors, may also cause the one or more processors to perform operations including generating a graphical user interface comprising a graphical representation of the building including the building equipment and the video device. The instructions, when executed by one or more processors, may also cause the one or more processors to perform operations including presenting the video data via the graphical user interface responsive to selection of the video device in the graphical representation of the building.

The building model may include a Building Information Model (BIM) of the building, the BIM indicating a location of the building equipment and a location of the video device. The instructions, when executed by one or more processors, may also cause the one or more processors to perform operations including determining, based on the BIM, that the video device is positioned to view the building equipment. The instructions, when executed by one or more processors, may also cause the one or more processors to perform operations including identifying the video device as being associated with the building equipment responsive to determining that the video device is positioned to view the building equipment.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a building automation system (BAS), according to an exemplary embodiment.

FIG. 2 is a block diagram of a waterside system which may be used to provide heating and/or cooling to the building of FIG. 1, according to an exemplary embodiment.

FIG. 3 is a block diagram of an airside system which may be used to provide heating and/or cooling to the building of FIG. 1, according to an exemplary embodiment.

FIG. 4 is a block diagram of a BAS which may be used to monitor and control building equipment in the building of FIG. 1, according to an exemplary embodiment.

FIG. 5 is a block diagram of a system for integrating BAS data with a building information model (BIM), according to an exemplary embodiment.

FIG. 6 is a block diagram illustrating the BAS-BIM integrator of FIG. 5 in greater detail, according to an exemplary embodiment.

FIG. 7 is a block diagram of another system for integrating BAS data with a BIM, according to an exemplary embodiment.

FIG. 8 a block diagram of a BAS controller which may be used to integrate BAS data with a BIM, according to an exemplary embodiment.

FIG. 9 is a user interface illustrating a graphical representation of a BIM with integrated BAS data, according to an exemplary embodiment.

FIG. 10 is a user interface illustrating a graphical representation of a BIM with integrated BAS data, according to an exemplary embodiment.

FIG. 11 is a block diagram of a system which may be used to identify video data capturing an event detection, according to an exemplary embodiment.

FIG. 12 is a user interface illustrating a building map identifying a plurality of event detections and a plurality of video devices, according to an exemplary embodiment.

FIG. 13 is a detailed view of a section of the user interface of FIG. 12 illustrating selectable elements responsive to the event detection, according to an exemplary embodiment.

FIG. 14 is a user interface displaying an interactive recording of video output of a video device proximate to the event detection, according to an exemplary embodiment.

FIG. 15 is a user interface illustrating selectable elements which can be used to request video output of a particular video device over a specified time segment, according to an exemplary embodiment.

FIG. 16 is a user interface displaying the video output requested via the user interface of FIG. 15, according to an exemplary embodiment.

FIG. 17 is a user interface displaying a live stream of video output of the video device proximate to the event detection, according to an exemplary embodiment.

FIG. 18 is a user interface displaying a graphical representation of a building including building equipment and a video device, according to an exemplary embodiment.

FIG. 19 is a user interface displaying a recorded feed of video output of the video device corresponding to a selectable element of the user interface, according to an exemplary embodiment.

FIG. 20 is a user interface displaying a graphical representation of building equipment and selectable elements including user input fields for building equipment commands, according to an exemplary embodiment.

FIG. 21 is a user interface displaying an application manager configured to navigate one or more applications of the user interface, according to an exemplary embodiment.

FIG. 22 is a user interface displaying a graphical representation of a building, elements displaying alarm information for the building, and selectable elements configured to navigate one or more buildings of the user interface.

FIG. 23 is a flowchart directed to a method of building automation, according to an exemplary embodiment.

### DETAILED DESCRIPTION

Referring generally to the FIGURES, a building automation system (BAS) with an integrated building information model (BIM) is shown, according to an exemplary embodiment. A BAS is, in general, a system of devices configured to control, monitor, and manage equipment in or around a building or building area. A BAS can include, for example, a HVAC system, a security system, a lighting system, a fire alerting system, any other system that is capable of managing building functions or devices, or any combination thereof.

A BIM is a representation of the physical and/or functional characteristics of a building. A BIM may represent structural characteristics of the building (e.g., walls, floors, ceilings, doors, windows, etc.) as well as the systems or components contained within the building (e.g., lighting components, electrical systems, mechanical systems, HVAC components, furniture, plumbing systems or fixtures, etc.). In some embodiments, a BIM is a 3D graphical model of the building. A BIM may be created using computer modeling software or other computer-aided design (CAD) tools and may be used by any of a plurality of entities that provide building-related services.

In some embodiments, a BIM represents building components as objects (e.g., software objects). For example, a BIM may include a plurality of objects that represent physical components within the building as well as building spaces. Each object may include a collection of attributes that define the physical geometry of the object, the type of object, and/or other properties of the object. For example, objects representing building spaces may define the size and location of the building space. Objects representing physical components may define the geometry of the physical component, the type of component (e.g., lighting fixture, air handling unit, wall, etc.), the location of the physical component, a material from which the physical component is constructed, and/or other attributes of the physical component.

The systems and methods described herein may be used to integrate BAS data with a BIM. Advantageously, the integration provided by the present invention allows dynamic BAS data (e.g., data points and their associated values) to be combined with the BIM. The integrated BIM with BAS data can be viewed using an integrated BAS-BIM viewer (e.g., CAD software, a CAD viewer, a web browser, etc.). The BAS-BIM viewer uses the geometric and location information from the BIM to generate 3D representations of physical components and building spaces.

In some embodiments, the BAS-BIM viewer functions as a user interface for monitoring and controlling the various systems and devices represented in the integrated BIM. For example, a user can view real-time data from the BAS and/or trend data for objects represented in the BIM simply by viewing the BIM with integrated BAS data. The user can view BAS points, change the values of BAS points (e.g., setpoints), configure the BAS, and interact with the BAS via the BAS-BIM viewer. These features allow the BIM with integrated BAS data to be used as a building control interface which provides a graphical 3D representation of the building and the equipment contained therein without requiring a user to manually create or define graphics for various building components. Additional features and advantages of the present invention are described in greater detail below.

The systems and methods described herein may also identify and/or otherwise detect faults. For example, the BAS may identify that an Air Handler Unit (AHU) has experienced a fault. The BAS may determine, based on the BIM, a location and/or a placement of the AHU within a building. For example, the BAS may determine that the AHU is located in zone 1 within floor 2 of the building. The BAS may identify at least one video device based on the location of the AHU. For example, the BAS may identify a camera (e.g., a video device). The BAS may identify the camera based on one or more relationships between the camera and the AHU. For example, the camera may also be located in zone 1 within floor 2 of the building.

In some embodiments, the BAS may determine, based on the BIM, a point in time when the AHU experienced the fault. For example, the BAS may determine that the fault was detected at 2:55:26 AM. The BAS may retrieve video output from the camera that is located in zone 1 within floor 2 of the building. The video output may correspond to a time segment that includes the point in time when the fault occurred and/or when the fault was detected. For example, the video output may comprise a segment of a recording (e.g., captured data) from the camera between 2:55:16 AM and 2:55:36 AM. The BAS may present the recording to a user via a display device. For example, the BAS can display the recording on a graphical user interface (GUI) via a screen (e.g., a display device) of a mobile phone. To continue this example, the mobile phone may correspond to and/or be associated with a building mechanic assigned to work on AHUs within the building. The BAS may allow the building mechanic (e.g., a user that is viewing the recording) to interact with the recording via the GUI. For example, selectable elements presented on the GUI may allow the building mechanic to fast forward through the recording, rewind the recording, zoom into the recording, zoom out of the recording, etc. The selectable elements may also include an option for the building mechanic to switch between the recording and a live stream of video output from the camera.

Some technical solutions of the present disclosure include integration of the BAS with the BIM to identify information associated with faults. For example, the BAS may utilize the BIM to identify cameras that are located proximate to pieces of equipment that have experienced faults. The BAS can relate fault data (e.g., information that describes a fault condition) to video device data to present a visual analysis of the detected fault through a user interface. For example, the BAS may generate a user interface that includes both an indication of a fault (via an alert on the user interface) and an element, which when selected, causes the user interface to display a video feed that includes a video of the area included the piece of building equipment.

The integration of video outputs (e.g., images and/or video captured by video devices) with alert indications provides some of the technical solutions described herein. For example, the inclusion of a video image along with a fault condition provides additional information that would otherwise may be absent from a fault alert. Stated otherwise, simply providing an indication of an alert may not include information that may be used to diagnose and/or alleviate the fault condition. For example, an alert that indicates a door failed to close may not include information as to what cause the door's failure (e.g., the door did not close). To continue this example, providing a video output of the door may provide information (e.g., an image or video) that can be used to diagnose the door's failure.

Additionally, some technical solutions described herein can include implementing a machine learning model configured and/or trained to detect objects and/or events occurring in video data. For example, the machine learning model can be configured to process video data from a camera of a building. The machine learning model can be trained to determine a potential cause of an occurrence of an event based on the video data. The machine learning model may also be configured and/or trained to provide an automated resolution to address the potential cause of the occurrence of the event. For example, the machine learning model can detect the cause of the event, and then provide a recommendation to the user outlining how to address the event. As another example, the machine learning model may be configured to trigger an automated resolution that operates building equipment to address the occurrence of the event. Processing these events manually by the user can be slow and time consuming, and in the event of an emergency, a fast resolution may be necessary. Implementing the machine learning model to determine a potential cause and initiate a resolution to address the potential cause can provide faster, more efficient, and safer building control than those that require manual diagnostics.

### Building Automation System and HVAC System

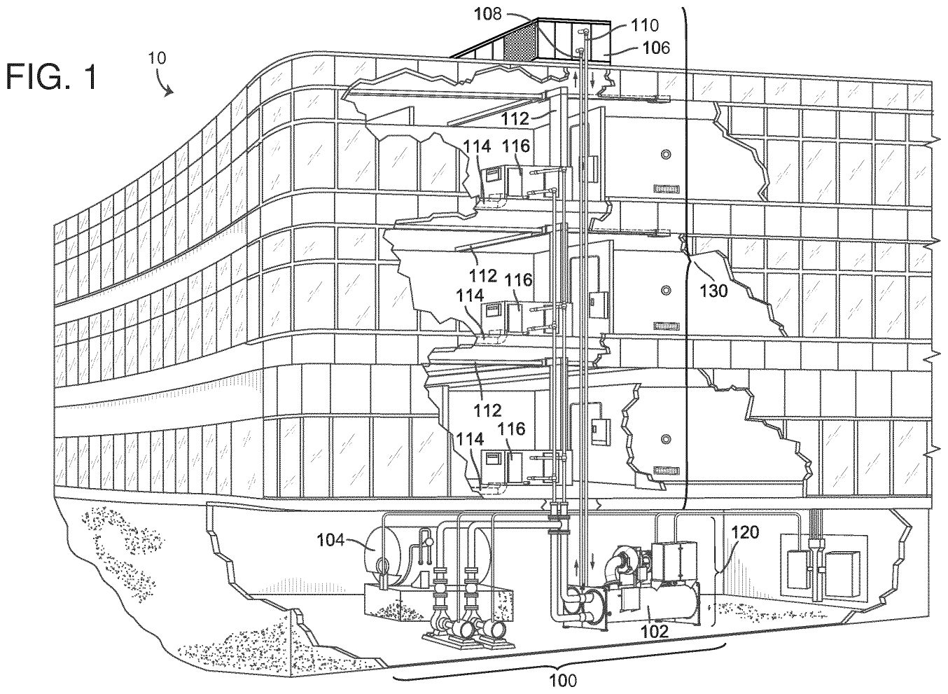

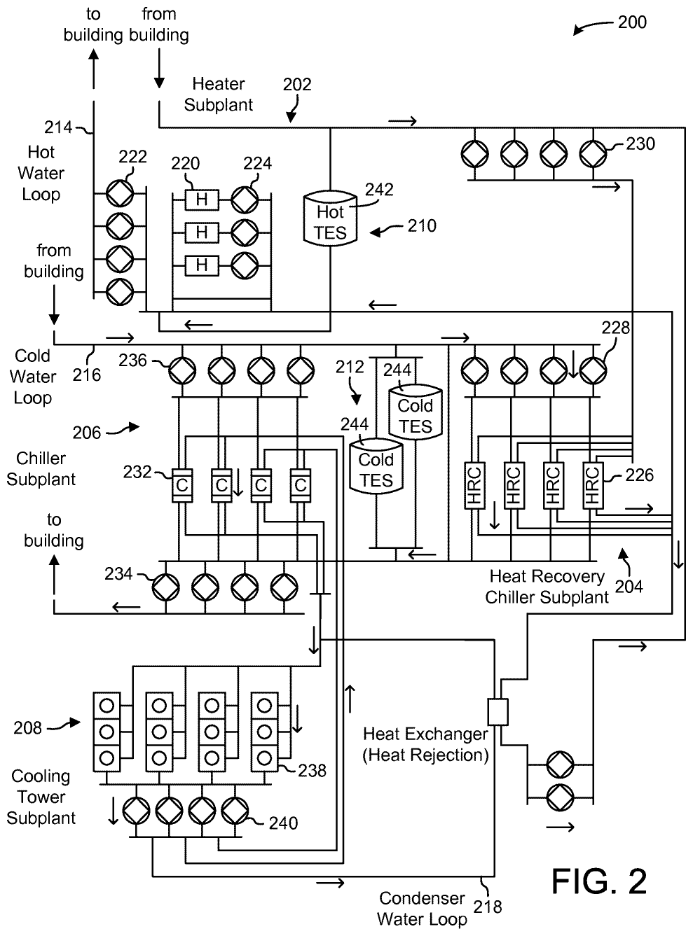

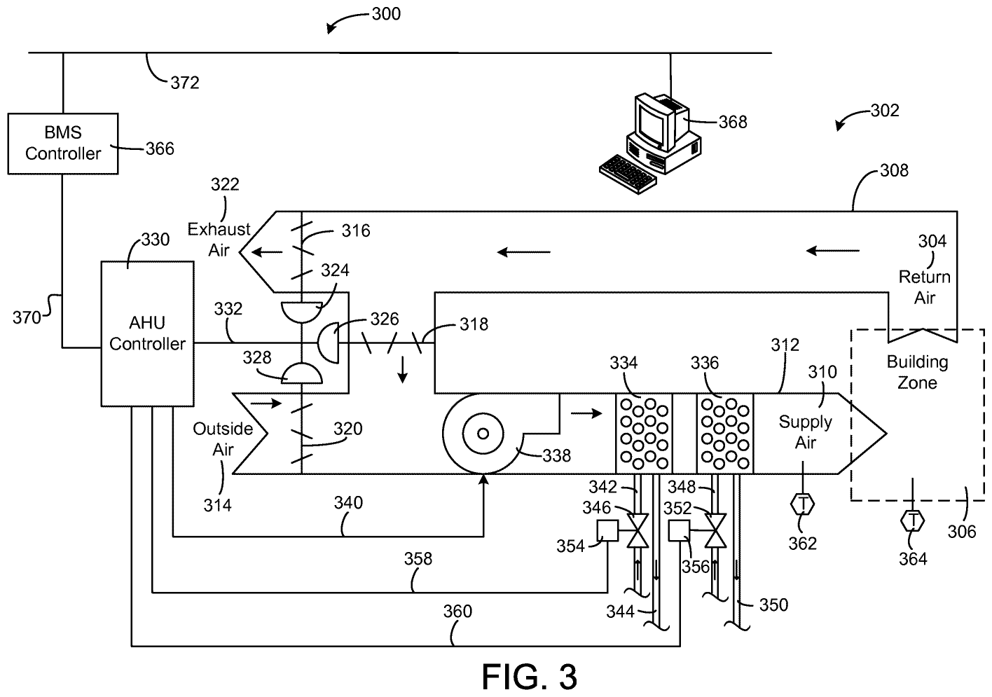

Referring now to FIGS. 1-4, an exemplary building automation system (BAS) and HVAC system in which the systems and methods of the present invention may be implemented are shown, according to an exemplary embodiment. Referring particularly to FIG. 1, a perspective view of a building 10 is shown. Building 10 is served by a BAS which includes a HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BAS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BAS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building automation system (BAS) controller 366 and a client device 368. BAS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BAS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BAS controller 366 may be separate (as shown in FIG. 3) or integrated. In an integrated implementation, AHU controller 330 may be a software module configured for execution by a processor of BAS controller 366.

In some embodiments, AHU controller 330 receives information from BAS controller 366 (e.g., commands, setpoints, operating boundaries, etc.) and provides information to BAS controller 366 (e.g., temperature measurements, valve or actuator positions, operating statuses, diagnostics, etc.). For example, AHU controller 330 may provide BAS controller 366 with temperature measurements from temperature sensors 362-364, equipment on/off states, equipment operating capacities, and/or any other information that can be used by BAS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BAS controller 366 and/or AHU controller 330 via communications link 372.

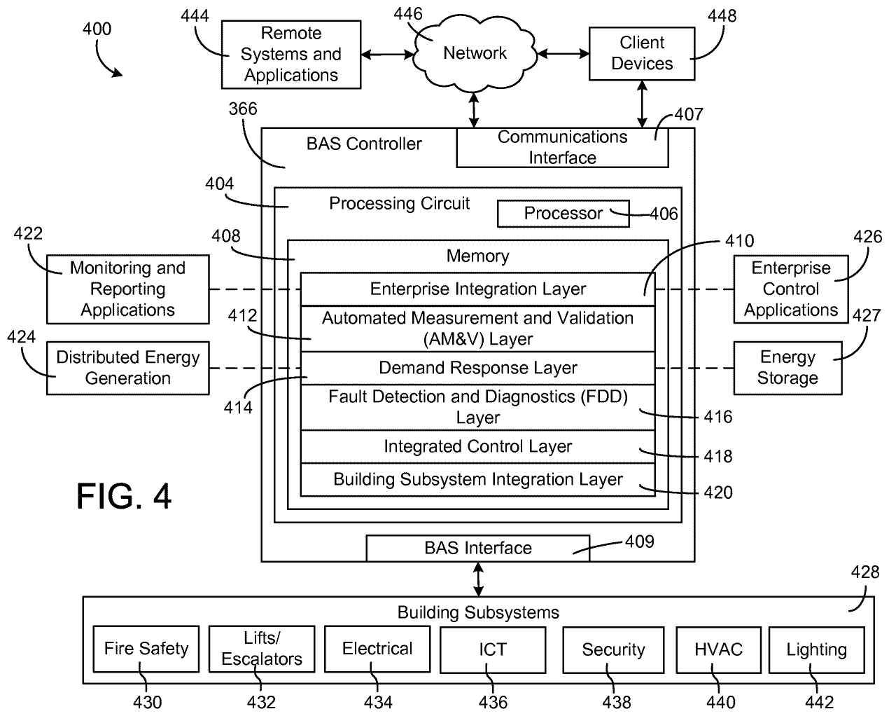

Referring now to FIG. 4, a block diagram of a building automation system (BAS) 400 is shown, according to an exemplary embodiment. BAS 400 may be implemented in building 10 to automatically monitor and control various building functions. BAS 400 is shown to include BAS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 366 is shown to include a communications interface 407 and a BAS interface 409. Interface 407 may facilitate communications between BAS controller 366 and external applications (e.g., monitoring and reporting applications 422, enterprise control applications 426, remote systems and applications 444, applications residing on client devices 448, etc.) for allowing user control, monitoring, and adjustment to BAS controller 366 and/or subsystems 428. Interface 407 may also facilitate communications between BAS controller 366 and client devices 448. BAS interface 409 may facilitate communications between BAS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 366 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 366 is implemented within a single computer (e.g., one server, one housing, etc.). In various other embodiments BAS controller 366 may be distributed across multiple servers or computers (e.g., that can exist in distributed locations). Further, while FIG. 4 shows applications 422 and 426 as existing outside of BAS controller 366, in some embodiments, applications 422 and 426 may be hosted within BAS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 366. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES tank 242, cold TES tank 244, etc.), or from other sources. Demand response layer 414 may receive inputs from other layers of BAS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### BAS-BIM Integration

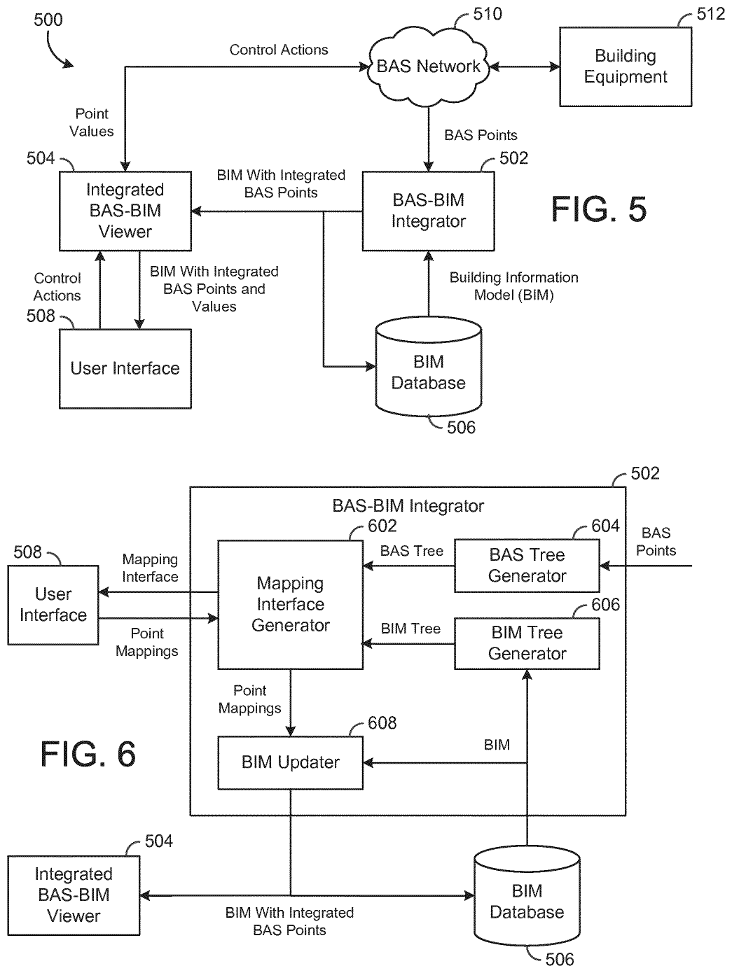

Referring now to FIG. 5, a system 500 for integrating building automation system data with a building information model is shown, according to an exemplary embodiment. A building information model (BIM) is a representation of the physical and/or functional characteristics of a building. A BIM may represent structural characteristics of the building (e.g., walls, floors, ceilings, doors, windows, etc.) as well as the systems or components contained within the building (e.g., lighting components, electrical systems, mechanical systems, HVAC components, furniture, plumbing systems or fixtures, etc.).

In some embodiments, a BIM is a 3D graphical model of the building. A BIM may be created using computer modeling software or other computer-aided design (CAD) tools and may be used by any of a plurality of entities that provide building-related services. For example, a BIM may be used by architects, contractors, landscape architects, surveyors, civil engineers, structural engineers, building services engineers, building owners/operators, or any other entity to obtain information about the building and/or the components contained therein. A BIM may replace 2D technical drawings (e.g., plans, elevations, sections, etc.) and may provide significantly more information than traditional 2D drawings. For example, a BIM may include spatial relationships, light analyses, geographic information, and/or qualities or properties of building components (e.g., manufacturer details).

In some embodiments, a BIM represents building components as objects (e.g., software objects). For example, a BIM may include a plurality of objects that represent physical components within the building as well as building spaces. Each object may include a collection of attributes that define the physical geometry of the object, the type of object, and/or other properties of the object. For example, objects representing building spaces may define the size and location of the building space. Objects representing physical components may define the geometry of the physical component, the type of component (e.g., lighting fixture, air handling unit, wall, etc.), the location of the physical component, a material from which the physical component is constructed, and/or other attributes of the physical component.

In some embodiments, a BIM includes an industry foundation class (IFC) data model that describes building and construction industry data. An IFC data model is an object-based file format that facilitates interoperability in the architecture, engineering, and construction industry. An IFC model may store and represent building components in terms of a data schema. An IFC model may include multiple layers and may include object definitions (e.g., IfcObjectDefinition), relationships (e.g., IfcRelationship), and property definitions (e.g., IfcPropertyDefinition). Object definitions may identify various objects in the IFC model and may include information such as physical placement, controls, and groupings. Relationships may capture relationships between objects such as composition, assignment, connectivity, association, and definition. Property definitions may capture dynamically extensible properties about objects. Any type of property may be defined as an enumeration, a list of values, a table of values, or a data structure.

A BIM can be viewed and manipulated using a 3D modeling program (e.g., CAD software), a model viewer, a web browser, and/or any other software capable of interpreting and rendering the information contained within the BIM. Appropriate viewing software may allow a user to view the representation of the building from any of a variety of perspectives and/or locations. For example, a user can view the BIM from a perspective within the building to see how the building would look from that location. In other words, a user can simulate the perspective of a person within the building.

Advantageously, the integration provided by system 500 allows dynamic BAS data (e.g., data points and their associated values) to be combined with the BIM. The integrated BIM with BAS data can be viewed using an integrated BAS-BIM viewer (e.g., CAD software, a CAD viewer, a web browser, etc.). The BAS-BIM viewer uses the geometric and location information from the BIM to generate 3D representations of physical components and building spaces. In some embodiments, the BAS-BIM viewer functions as a user interface for monitoring and controlling the various systems and devices represented in the integrated BIM. For example, a user can view real-time data from the BAS and/or trend data for objects represented in the BIM simply by viewing the BIM with integrated BAS data. The user can view BAS points, change the values of BAS points (e.g., setpoints), configure the BAS, and interact with the BAS via the BAS-BIM viewer. These features allow the BIM with integrated BAS data to be used as a building control interface which provides a graphical 3D representation of the building and the equipment contained therein without requiring a user to manually create or define graphics for various building components.

Still referring to FIG. 5, system 500 is shown to include a BAS-BIM integrator 502, an integrated BAS-BIM viewer 504, a BIM database 506, a user interface 508, a BAS network 510, and building equipment 512. In some embodiments, some or all of the components of system 500 are part of BAS 400. For example, BAS network 510 may be a building automation and control network (e.g., a BACnet network, a LonWorks network, etc.) used by BAS 400 to communicate with building equipment 512. Building equipment 512 may include any of the equipment described with reference to FIGS. 1-4. For example, building equipment 512 may include HVAC equipment (e.g., chillers, boilers, air handling units pumps, fans, valves, dampers, etc.), fire safety equipment, lifts/escalators, electrical equipment, communications equipment, security equipment, lighting equipment, or any other type of equipment which may be contained within a building.

In some embodiments, BAS-BIM integrator 502, integrated BAS-BIM viewer 504, BIM database 506, and user interface 508 are components of BAS controller 366. In other embodiments, one or more of components 502-508 may be components of a user device. For example, integrated BAS-BIM viewer 504 may be an application running on the user device and may be configured to present a BIM with integrated BAS points via a user interface (e.g., user interface 508) of the user device. BAS-BIM integrator 502 may be part of the same application and may be configured to integrate BAS points with a BIM model based on user input provided via user interface 508. In further embodiments, integrated BAS-BIM viewer 504 is part of a user device that receives a BIM with integrated BAS points from a remote BAS-BIM integrator 502. It is contemplated that components 502-508 may be part of the same system/device (e.g., BAS controller 366, a user device, etc.) or may be distributed across multiple systems/devices. All such embodiments are within the scope of the present disclosure.

Still referring to FIG. 5, BAS-BIM integrator 502 is shown receiving a BIM and BAS points. In some embodiments, BAS-BIM integrator 502 receives a BIM from BIM database 506. In other embodiments, the BIM is uploaded by a user or retrieved from another data source. BAS-BIM integrator 502 may receive BAS points from BAS network 510 (e.g., a BACnet network, a LonWorks network, etc.). The BAS points may be measured data points, calculated data points, setpoints, or other types of data points used by the BAS, generated by the BAS, or stored within the BAS (e.g., configuration settings, control parameters, equipment information, alarm information, etc.).

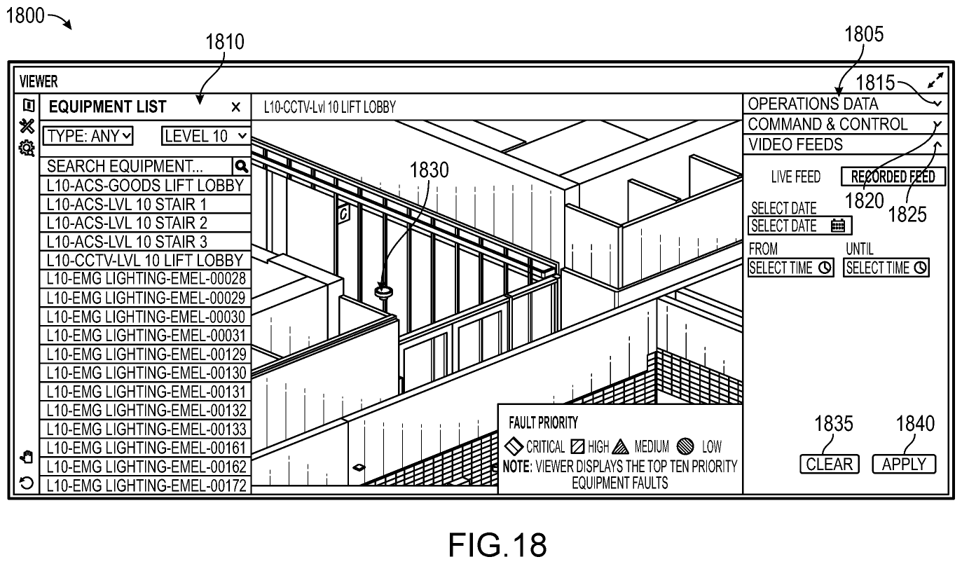

BAS-BIM integrator 502 may be configured to integrate the BAS points with the BIM. In some embodiments, BAS-BIM integrator 502 integrates the BAS points with the BIM based on a user-defined mapping. For example, BAS-BIM integrator 502 may be configured to generate a mapping interface presents the BAS points as a BAS tree and presents the BIM objects as a BIM tree. The BAS tree and the BIM tree may be presented to a user via user interface 508. The mapping interface may allow a user to drag and drop BAS points onto objects of the BIM or otherwise define associations between BAS points and BIM objects. An exemplary mapping interface is described in greater detail with reference to FIG. 18. In other embodiments, BAS-BIM integrator 502 automatically maps the BAS points to BIM objects based on attributes of the BAS points and the BIM objects (e.g., name, attributes, type, etc.).

In some embodiments, BAS-BIM integrator 502 updates or modifies the BIM to include the BAS points. For example, BAS-BIM integrator 502 may store the BAS points as properties or attributes of objects within the BIM (e.g., objects representing building equipment or spaces). The modified BIM with integrated BAS points may be provided to integrated BAS-BIM viewer 504 and/or stored in BIM database 506. When the BIM is viewed, the BAS points can be viewed along with the other attributes of the BIM objects. In other embodiments, BAS-BIM integrator 502 generates a mapping between BIM objects and BAS points without modifying the BIM. The mapping may be stored in a separate database or included within the BIM. When the BIM is viewed, integrated BAS-BIM viewer 504 may use the mapping to identify BAS points associated with BIM objects.

Integrated BAS-BIM viewer 504 is shown receiving the BIM with integrated BAS points from BAS-BIM integrator 502. Integrated BAS-BIM viewer 504 may generate a 3D graphical representation of the building and the components contained therein, according to the attributes of objects defined by the BIM. As previously described, the BIM objects may be modified to include BAS points. For example, some or all of the objects within the BIM may be modified to include an attribute identifying a particular BAS point (e.g., a point name, a point ID, etc.). When integrated BAS-BIM viewer 504 renders the BIM with integrated BAS points, integrated BAS-BIM viewer 504 may use the identities of the BAS points provided by the BIM to retrieve corresponding point values from BAS network 510. Integrated BAS-BIM viewer 504 may incorporate the BAS point values within the BIM to generate a BIM with integrated BAS points and values.

Integrated BAS-BIM viewer 504 is shown providing the BIM with integrated BAS points and values to user interface 508. User interface 508 may present the BIM with integrated BAS points and values to a user. Advantageously, the BIM with integrated BAS points and values may include real-time data from BAS network 510, as defined by the integrated BAS points. A user can monitor the BAS and view present values of the BAS points from within the BIM. In some embodiments, the BIM with integrated BAS points and values includes trend data for various BAS points. User interface 508 may display the trend data to a user along with the BIM.

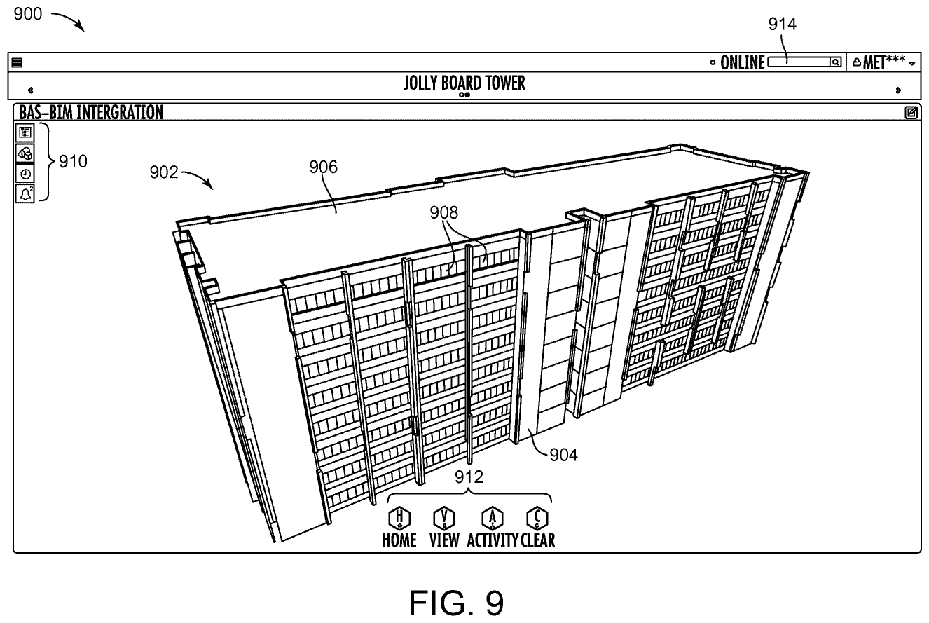

In some embodiments, integrated BAS-BIM viewer 504 receives control actions via user interface 508. For example, a user can write new values for any of the BAS points displayed in the BIM (e.g., setpoints), send operating commands or control signals to the building equipment displayed in the BIM, or otherwise interact with the BAS via the BIM. Control actions submitted via user interface 508 may be received at integrated BAS-BIM viewer 504 and provided to BAS network 510. BAS network 510 may use the control actions to generate control signals for building equipment 512 or otherwise adjust the operation of building equipment 512. In this way, the BIM with integrated BAS points and values not only allows a user to monitor the BAS, but also provides the control functionality of a graphical BAS management and control interface. Several examples of the control interface provided by the BIM with integrated BAS points and values are described in greater detail with reference to FIGS. 9-18.

Referring now to FIG. 6, a block diagram illustrating BAS-BIM integrator 502 in greater detail is shown, according to an exemplary embodiment. BAS-BIM integrator 502 is shown to include a BIM tree generator 606 and a BAS tree generator 604. BIM tree generator 606 may be configured to receive a BIM from BIM database 506. Alternatively, the BIM may be uploaded by a user or retrieved from another location. BIM tree generator 606 may generate a BIM tree based on the BIM. The BIM tree may include a hierarchical listing of BIM objects referenced in the BIM. BAS tree generator 604 may receive BAS points from the BAS and may generate a BAS tree based on the BAS points. The BAS tree may include a hierarchical listing of BAS points. Exemplary BAS and BIM trees are shown in FIG. 18.

BAS-BIM integrator 502 is shown to include a mapping interface generator 602. Mapping interface generator 602 may be configured to generate an interface for mapping BAS points to BIM objects. In some embodiments, the mapping interface includes the BAS tree and BIM tree. For example, the BAS tree may be displayed in a first portion of the mapping interface and the BIM tree may be displayed in a second portion of the mapping interface. The mapping interface may be presented to a user via user interface 508. A user can define point mappings by dragging and dropping BAS points from the BAS tree onto BIM objects in the BIM tree. Mapping interface generator 602 may receive the point mappings from user interface 508 and may provide the point mappings to BIM updater 608. An exemplary mapping interface which may be generated by mapping interface generator 602 is shown in FIG. 18.

BIM updater 608 may be configured to update or modify the BIM based on the BAS point mappings. For example, BIM updater 608 may store the BAS points as properties or attributes of objects within the BIM (e.g., objects representing building equipment or spaces). The modified BIM with integrated BAS points may be provided to integrated BAS-BIM viewer 504 and/or stored in BIM database 506. When the BIM is viewed, the BAS points mapped to a BIM object can be viewed along with other attributes of the BIM objects.

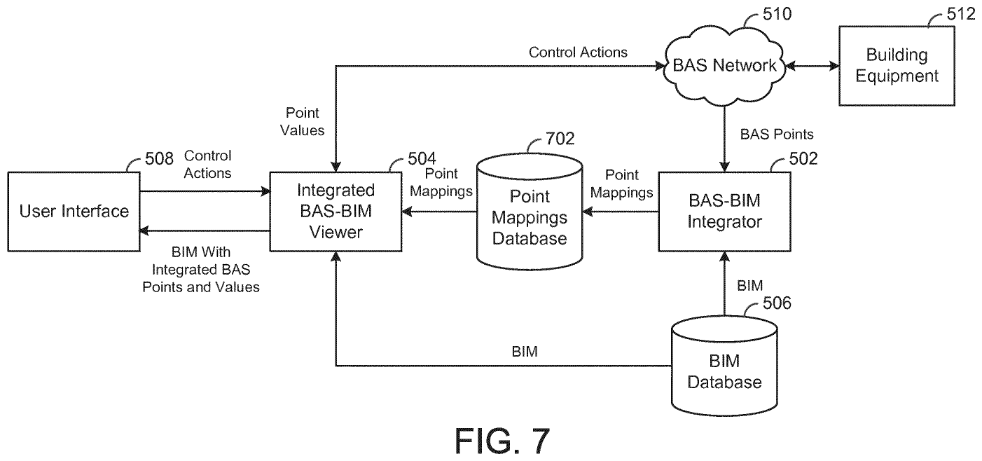

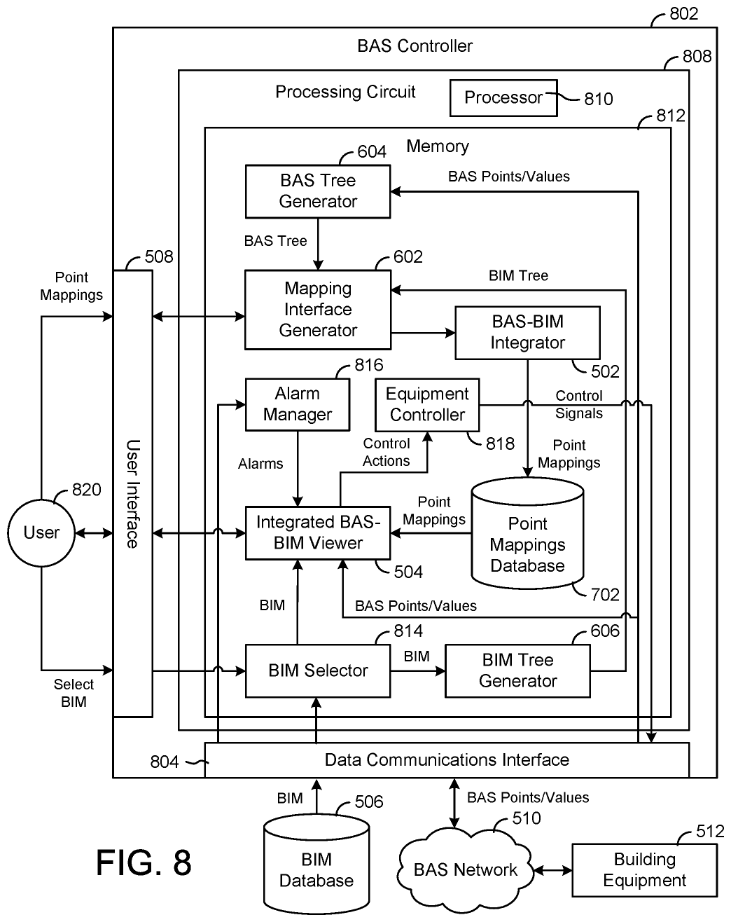

Referring now to FIG. 7, another system 700 for integrating building automation system data with a building information model is shown, according to an exemplary embodiment. System 700 is shown to include many of the same components as system 500. For example, system 700 is shown to include a BAS-BIM integrator 502, an integrated BAS-BIM viewer 504, a BIM database 506, a user interface 508, a BAS network 510, and building equipment 512.

System 700 is also shown to include a point mappings database 702. In the embodiment shown in FIG. 7, BAS-BIM integrator 502 does not modify the BIM to include the BAS points, but rather stores the point mappings in point mappings database 702. When the BIM is viewed, integrated BAS-BIM viewer 504 may retrieve the BIM from BIM database 506 and may retrieve the point mappings from point mappings database 702. Integrated BAS-BIM viewer 504 may use the point mappings to identify BAS points associated with the BIM objects.

Integrated BAS-BIM viewer 504 may generate a 3D graphical representation of the building and the components contained therein, according to the attributes of objects defined by the BIM. When integrated BAS-BIM viewer 504 renders the BIM, integrated BAS-BIM viewer 504 may use the identities of the BAS points provided by the point mappings to retrieve corresponding point values from BAS network 510. Integrated BAS-BIM viewer 504 may incorporate the BAS point values within the BIM to generate a BIM with integrated BAS points and values.

Integrated BAS-BIM viewer 504 is shown providing the BIM with integrated BAS points and values to user interface 508. User interface 508 may present the BIM with integrated BAS points and values to a user. Advantageously, the BIM with integrated BAS points and values may include real-time data from BAS network 510, as defined by the integrated BAS points. A user can monitor the BAS and view present values of the BAS points from within the BIM. In some embodiments, the BIM with integrated BAS points and values includes trend data for various BAS points. User interface 508 may display the trend data to a user along with the BIM.

Referring now to FIG. 8, a block diagram of a BAS controller 802 is shown, according to an exemplary embodiment. In some embodiments, many of the components of systems 500-700 are components of BAS controller 802. For example, BAS controller 802 is shown to include a BAS-BIM integrator 502, an integrated BAS-BIM viewer 504, a user interface 508, a mapping interface generator 602, a BAS tree generator 604, a BIM tree generator 606, and a point mappings database 702. These components may be the same or similar as previously described with reference to FIGS. 5-7. Controller 802 may also include some or all of the components of BAS controller 366, as described with reference to FIGS. 3-4.

Controller 802 is shown to include a data communications interface 804 and a processing circuit 808. The data communication interface 804 may facilitate communications between BAS controller 802 and external systems or applications (e.g., BIM database 506, BAS network 510, building equipment 512, a user device, etc.). The data communication interface 804 may include wired or wireless communications interfaces (e.g., jacks, antennas, transmitters, receivers, transceivers, wire terminals, etc.) for conducting data communications with BIM database 506, BAS network 510, or other external systems or devices. In various embodiments, communications via the data communication interface 804 may be direct (e.g., local wired or wireless communications) or via a communications network (e.g., a WAN, the Internet, a cellular network, etc.). For example, the data communication interface 804 may include an Ethernet card and port for sending and receiving data via an Ethernet-based communications link or network. In another example, the data communication interface 804 may include a WiFi transceiver for communicating via a wireless communications network, a cellular or mobile phone communications transceiver, or a power line communications interface.

The processing circuit 808 is shown to include a processor 810 and memory 812. Processor 810 may be a general purpose or specific purpose processor, an application specific integrated circuit (ASIC), one or more field programmable gate arrays (FPGAs), a group of processing components, or other suitable processing components. Processor 810 is configured to execute computer code or instructions stored in memory 812 or received from other computer readable media (e.g., CDROM, network storage, a remote server, etc.).

Memory 812 may include one or more devices (e.g., memory units, memory devices, storage devices, etc.) for storing data and/or computer code for completing and/or facilitating the various processes described in the present disclosure. Memory 812 may include random access memory (RAM), read-only memory (ROM), hard drive storage, temporary storage, non-volatile memory, flash memory, optical memory, or any other suitable memory for storing software objects and/or computer instructions. Memory 812 may include database components, object code components, script components, or any other type of information structure for supporting the various activities and information structures described in the present disclosure. Memory 812 may be communicably connected to processor 810 via the processing circuit 808 and may include computer code for executing (e.g., by processor 810) one or more processes described herein. When processor 810 executes instructions stored in memory 812, processor 810 generally configures BAS controller 802 (and more particularly the processing circuit 808) to complete such activities.

Still referring to FIG. 8, memory 812 is shown to include a BIM selector 814. The BIM selector 814 may be configured to receive a selected BIM from user 820. In some embodiments, user 820 uploads the BIM to BAS controller 802. In other embodiments, BIM selector 814 retrieves the BIM from BIM database 506. BIM selector 814 may provide the BIM to BIM tree generator 606 for use in generating the BIM tree. In some embodiments, BIM selector 814 provides the BIM to integrated BAS-BIM viewer 504. In other embodiments, BIM selector 814 provides the BIM tree to BAS-BIM integrator 502.

BAS tree generator 604 may receive the BAS points from BAS network 510 via the data communications interface 804 and may use the BAS points to generate a BAS tree. The BIM tree and the BAS tree may be provided to mapping interface generator 602. Mapping interface generator 602 uses the BAS tree and BIM tree to generate a mapping interface. The mapping interface may be presented to user 820 via user interface 508. The user interacts with the mapping interface to define point mappings. The point mappings may be stored in point mappings database 702 and/or used by BAS-BIM integrator 502 to modify the BIM.

Integrated BAS-BIM viewer 504 may receive the point mappings from point mappings database and may use the point mappings to identify BAS points associated with BIM objects referenced in the BIM. In other embodiments, integrated BAS-BIM viewer 504 receives a BIM with integrated BAS points from BAS-BIM integrator 502, as described with reference to FIG. 5. Integrated BAS-BIM viewer 504 may retrieve corresponding point values from BAS network 510 via the data communications interface 804. Integrated BAS-BIM viewer 504 may then present the BIM with integrated BAS points and values to user 820 via user interface 508.

Still referring to FIG. 8, memory 812 is shown to include an alarm manager 816 and an equipment controller 818. Alarm manager 816 may receive alarms from BAS network 510 or may identify alarms based on the values of the BAS points. For example, alarm manager 816 may compare the values of the BAS points to alarm thresholds. If a BAS point is not within a range of values defined by the alarm thresholds, alarm manager 816 may determine that an alarm condition exists for the BAS point. Alarm manager 816 may provide alarms to integrated BAS-BIM viewer 504. Integrated BAS-BIM viewer 504 may use the alarms to generate part of the user interface provided to user 820.

Equipment controller 818 may receive control actions from integrated BAS-BIM viewer 504. The control actions may be user-defined control actions provided via the integrated BAS-BIM viewing interface. Equipment controller 818 may use the control actions to generate control signals for building equipment 512 or otherwise adjust the operation of building equipment 512. In this way, the BIM with integrated BAS points and values not only allows a user to monitor the BAS, but also provides the control functionality of a graphical BAS management and control interface. Several exemplary graphical interfaces which may be generated by integrated BAS-BIM viewer 504 are described in greater detail with reference to FIGS. 9-18.

### User Interfaces

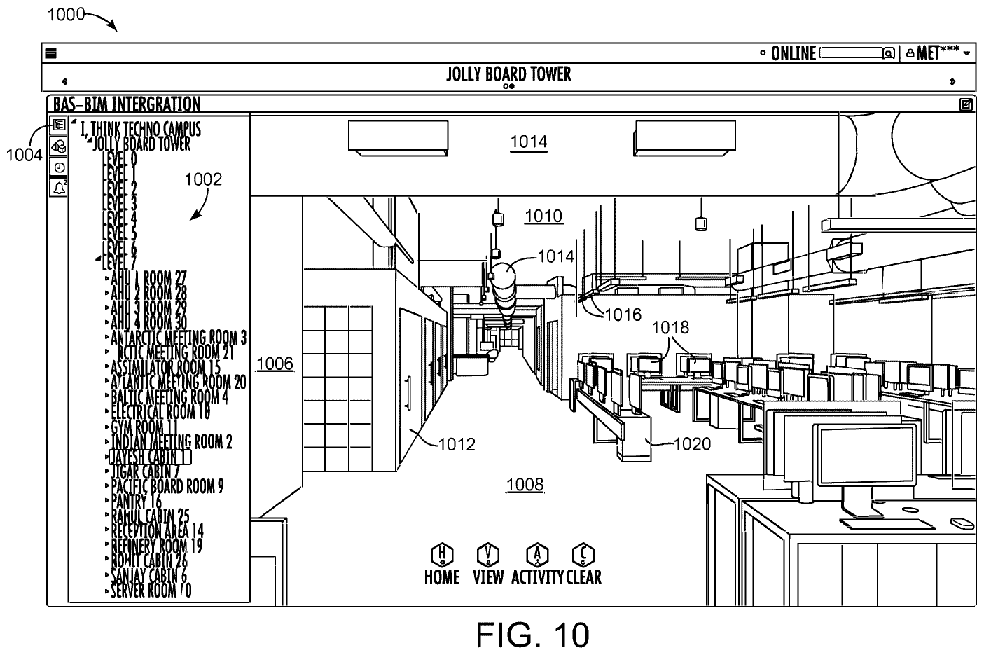

Referring now to FIGS. 9 and 10, several user interfaces 900-1800 which may be generated by BAS-BIM integrator 502 and integrated BAS-BIM viewer 504 are shown, according to an exemplary embodiment. In some embodiments, interfaces 900-1800 are web interfaces and may be presented via a web browser running on a user device. The user device may be a computer workstation, a client terminal, a personal computer, or any other type of user device. In various embodiments, the user device may be a mobile device (e.g., a smartphone, a tablet, a PDA, a laptop, etc.) or a non-mobile device. In other embodiments, interfaces 900-1800 are presented via a specialized monitoring and control application. The application may run on BAS controller 366, on a computer system within BAS 400, on a server, or on a user device. In some embodiments, the application is a mobile application configured to run on a mobile device.

Referring particularly to FIG. 9, an integrated BAS-BIM viewer interface 900 is shown, according to an exemplary embodiment. Interface 900 may be generated by integrated BAS-BIM viewer 504 to view and interact with a BIM with integrated BAS points and values. Interface 900 is shown to include a perspective view of a building 902. Building 902 is shown to include walls 904, a roof 906, and windows 908. The geometry and locations of components 904-906 may be defined by the BIM objects within the BIM model.

Interface 900 may be interactive and may allow a user to view building 902 from multiple different angles and/or perspectives. For example, interface 900 may provide interface options for zooming in, zooming out, panning vertically or horizontally, rotating the view, and/or otherwise changing the perspective. View buttons 912 may be used to select a particular view (e.g., top, side, front, back, left, right, back, perspective, etc.) of building 902. Navigation buttons 910 may be used to display a tree of BIM objects, filter the BIM objects (e.g., by type, by location, etc.), display any alarms provided by the BAS, or otherwise manipulate the view of building 902. Search box 914 can be used to search for particular BIM objects, search for BAS points, search for a particular room or zone, and/or search for building equipment. Selecting an item via navigation buttons 910 or search box 914 may change the view of building 902 based on the user selection (e.g., to view a selected component, to hide components, etc.).

Referring now to FIG. 10, another integrated BAS-BIM viewer interface 1000 is shown, according to an exemplary embodiment. Interface 1000 may be generated by integrated BAS-BIM viewer 504 to view and interact with a BIM with integrated BAS points and values. Interface 1000 shows a view of building 902 from a location within building 902. Interface 1000 is shown to include structural components of building 902 such as walls 1006, floor 1008, ceiling 1010, and doors 1012. Interface 1000 also displays HVAC components 1014 (e.g., air ducts), lighting components 1016 (e.g., lighting fixtures), electronic components 1018 (e.g., computer monitors), and furniture 1020 (e.g., desks). The geometry and locations of components 1006-1020 may be defined by the BIM objects within the BIM model.

Interface 1000 is shown to include an object tree 1002. Object tree 1002 may be displayed in response to selecting tree button 1004. Object tree 1002 includes a hierarchical representation of building 902 and the various spaces and components contained therein. For example, object tree 1002 is shown to include objects representing a campus, a particular building within the campus (e.g., Jolly Board Tower), levels within the building (e.g., level 0, level 1, level 2, etc.), and spaces/components within each level (e.g., conference rooms, offices, AHUs, etc.). Selecting any of the objects displayed in object tree 1002 may cause interface 1000 to display the selected object or change the view to show the selected object.

BAS with Video Feed Integration

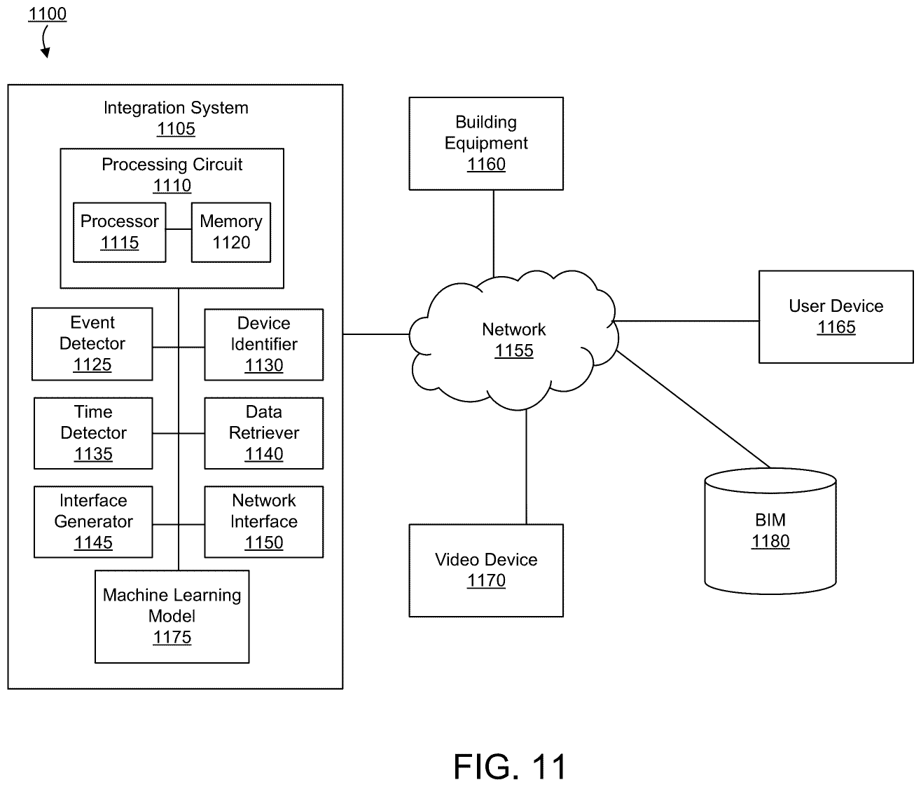

FIG. 11 depicts a system 1100, according to some embodiments. The system 1100 may include at least one of the various systems described herein. For example, the system 1100 may include the BAS 400. As another example, the system 1100 may be implemented as the BAS 400. In some embodiments, systems, components, and/or devices of the system 1100 may be added, removed, combined, separated, modified, and/or otherwise changed. For example, a device that is shown to include a first component and a second component may be modified to have the first component and the second component combined. In some embodiments, the system 1100 can include at least one of various components and/or devices described herein. For example, the system 1100 may include BAS controller 366. In some embodiments, the system 1100 may perform similar functionality to that of the various systems, devices, and/or components described herein. For example, the system 1100 may perform operations similar to that of the alarm manager 816.

The system 1100 may include at least one integration system 1105, at least one network 1155, at least one piece of building equipment 1160, at least one user device 1165, at least one video device 1170, and at least one Building Information Model (BIM) 1180. In some embodiments, the integration system 1105, the building equipment 1160, the user device 1165, the video device 1170, and the BIM 1180 of the system 1100 may communicate via the network 1155. In some embodiments the integration system 1105 may retrieve data relating to one or more components. For example, the integration system 1105 may communicate with the one or more pieces of building equipment 1160 and/or building equipment 1160. As another example, the integration system 1105 may communicate with the video device 1170.

The network 1155 may include at least one of the various networks and/or communication medium described herein. For example, the network 1155 may include the communications network 446. As another example, the network 1155 may perform operations similar to that of the BAS network 510. In some embodiments, at least one of the various types of communications described herein may be performed via and/or over the network 1155.

In some embodiments, the building equipment 1160 may include at least one of the various pieces of building equipment described herein. For example, the building equipment 1160 may include the building equipment 512. As another example, the building equipment 1160 may include HVAC equipment (e.g., chillers, boilers, air handling unit pumps, fans, valves, dampers, etc.), fire safety equipment, lifts/escalators, electrical equipment, communications equipment, security equipment, lighting equipment, or any other type of equipment which may be contained within a building. In some embodiments, data relating to building equipment 1160 (e.g., performance thresholds, standard ranges of operation, etc.) may be stored in the BIM 1180 and/or a database (e.g., BIM database 506).

In some embodiments, the video device 1170 may comprise one of a plurality of video devices located throughout a building. In some embodiments, the video device 1170 may be a camera. In some embodiments, the camera may be configured to capture video data corresponding to one or more components of building equipment 1160. For example, the camera may be mounted to a corner of a ceiling such that an orientation of the camera provides video data that may capture an operation of a door located proximate to the camera. In some embodiments, the video data of the camera may comprise real-time video footage (e.g., a live stream, a live feed, etc.) and/or recorded video footage. For example, the recorded video footage may comprise one or more segments of recorded feed (e.g., a clip) captured by the camera. The one or more segments of recorded video footage (e.g., a recorded video feed) may comprise any duration from any timespan and/or date range during which the camera captured video data.

In some embodiments, the user device 1165 may include at least one of the various user devices described herein. For example, the user device 1165 may include the clint device 368. In some embodiments, the user device 1165 may perform operations similar to that of the various user devices described herein. For example, the user device 1165 may perform operations similar to that of the client device 448. In some embodiments, the user device 1165 may include at least one of the various components of the user devices described herein. For example, the user device 1165 may include at least one of a screen, a monitor, a display, etc.

In some embodiments, the user device 1165 may generate and/or provide a user interface that fits a dimension (e.g., a screen) of the user device 1165. For example, the user device 1165 may be a mobile device comprising a smaller display area for the user interface than if the user device 1165 were a desktop monitor. In some embodiments, the user device 1165 may include and/or be a portable device that can be used inside and/or outside of the building (e.g., the user device 1165 may be a personal mobile device of a building executive, operator, technician, mechanic, etc.). In some embodiments, the user device 1165 may operate only within the building (e.g., the user device 1165 may be mounted to a wall of the building and the user device 1165 may contain security precautions that restrict operation of the device to a local network, etc.).

In some embodiments, the integration system 1105 may include at least one of the systems described herein. For example, the integration system 1105 may include the BAS 400. As another example, the integration system 1105 may be implemented as the BAS 400. In some embodiments, the integration system 1105 may communicate with at least one of the various systems, components and/or devices described herein. For example, the integration system 1105 may retrieve data from the BIM 1180 (e.g., BIM database 506). To continue this example, the integration system 1105 may contain at least one of various components of and/or may perform similar functionality to that of the BAS-BIM integrator 502.

In some embodiments, the integration system 1105 may include at least one of the various components and/or devices described herein. For example, the integration system 1105 may include the BAS controller 366. In some embodiments, the integration system 1105 may include at least one processing circuit 1110, at least one event detector 1125, at least one device identifier 1130, at least one time detector 1135, at least one data retriever 1140, at least one interface generator 1145, and at least one network interface 1150. In some embodiments, the integration system 1105 may include at least one machine learning model 1175.

In some embodiments, the processing circuit 1110 may contain at least one of the various hardware, circuitry, and/or circuit components described herein. For example, the processing circuit 1110 may include components similar to that of the processing circuit 404. In some embodiments, the processing circuit 1110 may perform operations similar to that of the various hardware, circuitry, and/or circuit components described herein. For example, the processing circuit 1110 may perform operations similar to that of the processing circuit 808.

In some embodiments, the processing circuit 1110 may include at least one processor 1115 and memory 1120. In some embodiments, the processors 1115 may contain at least one of various components of and/or may perform similar functionality to that of the processor 406 and/or the processor 810. In some embodiments, memory 1120 may include at least one of the various types and/or forms of memory described herein. For example, memory 1120 may include RAM. As another example, memory 1120 may include memory 408. In some embodiments, memory 1120 may store instructions and/or computer code that causes the processors 1115 to perform at least one of the various operations and/or processes described herein.

In some embodiments, the event detector 1125 may detect one or more event occurrences within the building. For example, an event occurrence within the building may be a fault event. As another example, an event within the building may be based on and/or responsive to one or more user interactions (e.g., user selects building equipment 1160, user selects video device). In some embodiments, the event detector 1125 may detect one or more faults within the building. For example, the event detector 1125 may identify an activated alarm (e.g., a fire alarm) within the building. As another example, the event detector 1125 may detect an operational value of building equipment (e.g., building equipment 1160) that falls outside of a predetermined range of operational values as stored in the BIM 1180 (e.g., in the BIM database 506). In some embodiments, the event detector 1125 may detect one or more faults within and/or with respect to the building 10. For example, the event detector 1125 may detect an equipment failure regarding a given AHU (e.g., equipment 1160).

In some embodiments, the event detector 1125 uses one or more fault detection or diagnostic (FDD) models or processes to detect faults or problems associated with the building equipment 1160, predict the root causes of the faults or problems, and/or determine actions that are predicted to resolve the root causes of the faults or problems. Several examples of FDD models and processes that can be used by the event detector 1125 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014, the entire disclosures of all of which are incorporated by reference herein.

In some embodiments, the event detector 1125 may detect one or more event conditions. In some embodiments, the event conditions may include one or more fault conditions. For example, the event detector 1125 may detect a fault condition for a piece of equipment (e.g., the building equipment 1160, video device 1170, etc.). In some embodiments, the event detector 1125 may detect the fault conditions based on information pertaining to the pieces of building equipment. For example, the event detector 1125 may receive operational data and/or timeseries for an AHU (e.g., a piece of building equipment 1160) and the operational data may indicate a fault condition. In some embodiments, the event detector 1125 may detect the fault condition by performing operations similar to that of the alarm manager 816.

In some embodiments, the event detector 1125 may detect fault conditions responsive to receiving messages from one or more components. For example, the event detector 1125 may receive detect a fault condition responsive to receiving a message that indicates an occurrence of a fault condition.

In some embodiments, the event detector 1125 may detect faults that relate to building security (e.g., detecting that a door which should remain closed has been opened, detecting that a door has been left open for an extended period of time, etc.). The event detector 1125 may determine a location within the building where the fault was detected (e.g., the fire alarm is located in zone 5 of the building, the door that has been left open is located in zone 2 within floor 3 of the building, etc.). In some embodiments, the event detector 1125 may determine the location within the building where the fault was detected based on data from the BIM 1180 (e.g., from the BIM database 506). For example, the event detector 1125 may determine the location of the fault within the building 10.

In some embodiments, the event conditions may include a user selected event condition. For example, the event detector 1125 may detect a user selected event condition for a piece of equipment (e.g., the building equipment 1160, video device 1170). In some embodiments, the user device 1165 may display a user interface for a piece of equipment for the event condition is selected from. In some embodiments, the user selected event condition may relate to a fault condition. For example, if a past fault condition was addressed, the user device 1165 may display information associated with the fault condition and/or a corresponding piece of equipment. A selection of the information or the piece of equipment may trigger the event condition. The resulting event condition may relate to the efficacy of the resolution of the past fault condition.

In some embodiments, the event detector 1125 may detect a user selected event condition that relates to the video device 1170. For example, the user may select a video device 1170 that has been recently adjusted and/or installed. The event detector 1125 may detect and/or otherwise identify the selected event. In some embodiments, the event detector 1125 may determine a status or operational setting of the video device 1170 to provide information associated with the video device 1170.

In some embodiments, the device identifier 1130 may identify one or more devices. For example, the device identifier 1130 may identify the video devices 1170. In some embodiments, the device identifier 1130 may identify the video devices 1170 using information associated with the building equipment 1160. For example, the device identifier 1130 may identify the video devices 1170 based on a location of a door (e.g., a piece of building equipment 1160) within the building 10. In some embodiments, the device identifier 1130 identifies one or more of the video devices 1170 (e.g., video cameras, still cameras, etc.) positioned to view a location of the event detected by the event detector 1125. For example, each event detected by the event detector 1125 may include attributes defining the location of the event and the time at which the event occurs (e.g., one or more timestamps, a start time and/or an end time, a time period during which the event occurs, etc.). The device identifier 1130 may identify one or more of the video devices 1170 positioned to view the location of the event at the time of the event.

In some embodiments, the device identifier 1130 may identify the video devices 1170 responsive to the event detector 1125 detecting a fault within the building. For example, the event detector 1125 may communicate with device identifier 1130 responsive to the event detector 1125 detecting a fault condition. As another example, the event detector 1125 may communicate with the device identifier 1130 responsive to the event detector 1125 determining a location within the building where the fault was detected.

In some embodiments, the device identifier 1130 may identify the video devices 1170 using information that is provided by the event detector 1125. For example, the event detector 1125 may determine that a door that has been left open for two minutes (e.g., a fault condition) is located in zone 2 of floor 3 of the building 10. To continue this example, event detector 1125 may provide the location of the door to the device identifier 1130 and the device identifier 1130 may identify the video devices 1170 based on the location of the door.

In some embodiments, the device identifier 1130 may identify the video devices 1170 proximate to the location of a fault based on data from the BIM 1180 (e.g., from the BIM database 506). For example, the device identifier 1130 may identify the video devices 1170 responsive to the BIM 1180 indicating the video devices 1170 are located on a given floor of the building 10.

In some embodiments, the device identifier 1130 may identify the video devices 1170 proximate to the location of building equipment based on data from the BIM 1180. For example, the device identifier 1130 may identify the video device 1170 responsive to the BIM 1180 indicating that the video device 1170 is positioned to view the building equipment 1160, and the video device 1170 is thereby associated with the building equipment 1160. In another example, the device identifier 1130 may identify the video device 1170 responsive to the BIM 1180 indicating the video device 1170 is located in the same room as the building equipment 1160.

In some embodiments, the time detector 1135 may determine a point in time. For example, the time detector 1135 may determine a point in time for which the fault condition was detected. Stated otherwise, the time detector 1135 may determine when (e.g., a point in time) the event detector 1125 detected a fault condition. In some embodiments, the point in time for which the fault condition was detected may include at least one of when the fault occurred, when a component determined that a fault occurred, when a component failed to communicate, when a component failed to perform a schedule operations, and/or various possible combinations.

In some embodiments, the time detector 1135 may determine the point in time using information describing the fault condition. For example, the event detector 1125 may provide, to time detector 1135, time series data that pertains to the piece of equipment that has experienced the fault condition. In some embodiments, the time detector 1135 may determine, based on the time series data, when the fault condition was detected. For example, the time detector 1135 may determine when a controller went offline based on timestamp of a last transmission.

In some embodiments, the time detector 1135 may determine a time segment. For example, the time detector 1135 may determine a time segment to retrieve data captured by the video devices 1170. In some embodiments, the time detector 1135 may determine the time segment based on the point in time. For example, the time detector 1135 may determine that a fault occurred at 10:00 AM (e.g., a point in time) and the time detector 1135 may determine a time segment that spans prior to (e.g., before) and/or after the point in time. Stated otherwise a time segment may be 9:59 AM to 10:00 AM. In some embodiments, the time detector 1135 may determine the time segment to have the video output include data corresponding to events leading up to the fault condition as well as events occurring after the fault condition.

In some embodiments, the time detector 1135 may detect, responsive to the event detector 1125 detecting a fault within the building, a time stamp at which the fault was detected by the event detector 1125. For example, time detector 1135 may detect that the event detector 1125 detected a fire alarm that was activated within zone 5 of the building at 4:46:23 PM. As another example, the time detector 1135 may detect that the event detector 1125 detected a user selected event condition that was activated within zone 3 of the building at 3:35:48 AM. In some embodiments, the time detector 1135 may use the time stamp to detect a time interval surrounding the time stamp. For example, a time interval may include an interval from 4:46:03 PM through 4:46:43 PM. In some embodiments, the time interval may be detected so that a user (e.g., a building security officer, a building mechanic, a building technician, etc.) can understand events that may have transpired prior to and following the time stamp at which the fault was detected.

In some embodiments, the data retriever 1140 may retrieve data. For example, the data retriever 1140 may access a BIM 1180 that stores operational data (e.g., the BIM database 506) relating to building equipment 1160. In some embodiments, the data retriever 1140 can retrieve predetermined operational thresholds relating to performance of building equipment 1160 to compare against real-time performance data of building equipment 1160. The data retriever 1140 may communicate differences between the predetermined operational thresholds and the real-time performance data of building equipment 1160 to the event detector 1125.

In some embodiments, the data retriever 1140 may retrieve data relating to video devices 1170 (e.g., cameras) located throughout the building. For example, the data retriever 1140 may retrieve data captured by the video devices 1170. In some embodiments, the data retriever 1140 may retrieve data that was captured during the time segment. For example, the data retriever 1140 may retrieve a video output that was captured by the video devices 1170 during the time segment. Various types of data sources and types of data which can be retrieved by the data retriever 1140 are described in detail in U.S. patent application Ser. No. 18/633,068 filed Apr. 11, 2024, the entire disclosure of which is incorporated by reference herein.

In some embodiments, the integration system 1105 may initiate an automated video gathering process. The automated video gathering process may include identifying a video device associated with building equipment. For example, the device identifier 1130 of the integration system 1105 may identify a video device 1170 associated with building equipment 1160. Identifying the video device may be based on a building model of the building. For example, the device identifier 1130 may use a building model of the BIM 1180 to identify the video device 1170. The automated video gathering process may retrieve video data captured by the video device during a time segment of the occurrence of the event. For example, the integration system 1105 may use the time detector 1135 to determine a time segment where the event occurred. The data retriever 1140 may retrieve the video data captured by the video device 1170 during that time segment.

In some embodiments, the integration system 1105 may determine a potential cause of the occurrence of an event. For example, the integration system 1105 may perform a diagnostic process using video data to determine a potential cause of the occurrence of the event. In some embodiments, the video device 1170 may capture the video data. In some embodiments, the diagnostic process includes referencing the video data to a stored list of potential cause for the event. For example, if the video data indicates that there is a fire, and the list of potential causes includes a gas fire, electrical fire, flood, and chemical leak, the integration system 1105 may filter out flood and chemical leak as potential causes.

As a non-limiting example, an event may include a zone temperature for a building exceeding a setpoint temperature by a given amount. In this example, the zone temperature exceeding the setpoint temperature may result in a detection of an event (e.g., the zone temperature exceeds the setpoint temperature). To continue this example, the integration system 1105 may determine a location of the event (e.g., what zone of the building). The integration system 1105 may retrieve a list of video devices proximate to the zone of the building. In this example, the integration system 1105 may access video feeds captured and/or produced by the video devices. To continue this example, the integration system 1105 may execute a machine learning model to evaluate the video feeds for potential causes of the event (e.g., what is causing the zone temperature to exceed the temperature setpoint). In this example, the integration system 1105 may determine that the root cause (e.g., what caused the occurrence of the event) is that an actuator, which controls a damper, failed and accordingly the position of the damper cannot be changed. The inability to control the damper may prevent an increase in the amount of cool air that can be provided to the zone which is resulting in the zone temperature exceeding the setpoint temperature.

In some embodiments, the diagnostic process of the integration system 1105 may include using the video data as an input to a machine learning model 1175. The machine learning model can be configured and/or trained to detect objects and/or events occurring in the video data. One example of a machine learning model configured to detect objects and/or events occurring in the video data is described in detail in U.S. patent application Ser. No. 18/790,348 filed Jul. 31, 2024, the entire disclosure of which is incorporated by reference herein. In some embodiments, the machine learning model 1175 includes some or all of the features of the models described in the '348 application. For example, if the video data indicates that there is a fire, and that the piece of equipment in the video data is a generator, the machine learning model 1175 may determine that a generator fire is a potential cause of the event. In some embodiments, the machine learning model 1175 may process the video data to determine the status of building equipment 1160. For example, the machine learning model 1175 may process the video data and determine that a window was broken, and update the status of the window to broken.

In some embodiments, the machine learning model 1175 may be a neural network. For example, the machine learning model 1175 may be a neural network trained iteratively using a backpropagation algorithm. In some embodiments, the machine learning model 1175 may be a pre-trained transformer (e.g., generative pre-trained transformer (GPT)) or any other type of generative artificial intelligence model. Several examples of generative artificial intelligence models which can be used as the machine learning model 1175 are described in detail in U.S. patent application Ser. No. 18/419,449 filed Jan. 22, 2024, the entire disclosure of which is incorporated by reference herein. In some embodiments, the machine learning model 1175 may be a regression tree. For example, the machine learning model 1175 may be a regression tree trained using recursive binary splitting. In some embodiments, the machine learning model 1175 may be trained via supervised learning (e.g., linear regression, K-Nearest Neighbors (KNN), gradient descent). In some embodiments, the machine learning model 1175 may be trained via unsupervised learning (e.g., clustering, association rules, dimensionality reduction).

In some embodiments, the machine learning model 1175 may receive feedback from the user regarding the accuracy of the potential cause of the event. For example, if the machine learning model 1175 determines that a fire is the potential cause of the event, but the real cause of the event is a flood, the user may provide feedback to the machine learning model 1175. In some embodiments, the machine learning model 1175 may be updated based on received feedback. As a non-limiting example, if the machine learning model 1175 is trained using backpropagation, the machine learning model 1175 may update its weights and biases responsive to feedback that the machine learning model 1175 predicted a potential cause of an event incorrectly. Several examples of a machine learning model which can be trained to predict root causes of various events is described in detail in U.S. patent application Ser. No. 18/661,045 filed May 10, 2024, the entire disclosure of which is incorporated by reference herein. In some embodiments, the machine learning model 1175 includes some or all of the features of the models described in the '045 application.

In some embodiments, the diagnostic process of the integration system 1105 may include asking the user questions based on the video data. For example, if the video data indicates that there is flooding in a bathroom of a building, the system 1100 may ask the user about the history of plumbing maintenance in the building. Based on the response from the user, the integration system 1105 may determine that a pipe bursting is a potential cause of the event.

In general, the diagnostic process of the integration system 1105 may include identifying objects or events occurring in the video data (e.g., by automatically by machine learning model 1175 or by asking a user questions about what the user sees in the video data) and using the identified objects or events occurring in the video data to determine the root cause of the event. The integration system 1105 can use the objects or events identified in the video data to confirm or exclude one or more root causes of the event from a set of multiple potential root causes. For example, if a potential root cause of the detected event is associated with a particular object or event identified in the video data (e.g., pipe bursting, equipment not operating, damper stuck open or closed, etc.), that root cause may be assigned a higher likelihood of being the actual root cause of the detected event and/or confirmed as the actual root cause. Conversely, if a potential root cause is inconsistent with a particular object or event identified in the video data, that root cause may be assigned a lower likelihood of being the actual root cause of the detected event and/or excluded as the actual root cause. Several examples diagnostic processes and interactive (e.g., chat bot) interfaces which can be used to confirm or exclude one or more potential root causes as the actual root cause of a detected event are described in detail in U.S. patent application Ser. No. 18/419,449 filed Jan. 22, 2024, the entire disclosure of which is incorporated by reference herein.

In some embodiments, the integration system 1105 may aid in addressing the potential cause of the event. For example, the integration system 1105 may initiate an automated resolution to address the potential cause of the event. In some embodiments, the automated resolution may include performing an automated action (e.g., controlling equipment, shutting off power, shutting off water) and/or providing a recommendation to the user. In some embodiments, the automated resolution may be based on the filtered list of potential causes. In some embodiments, the automated resolution may be based on the machine learning model 1175 determination of a potential cause of the event. In some embodiments, the automated resolution may be based on user responses to questions from the system 1100 based on the video data.

As a non-limiting example, if the potential causes include a gas fire and an electrical fire, the automated resolution may include multiple recommendations of addressing both a gas fire and an electrical fire. In another non-limiting example, the automated resolution may include one recommendation that would address a gas fire and an electrical fire. In some embodiments, the recommendation may be based on a standard operating procedure (SOP) stored by the BAS. For example, for a fire, the SOP may recommend that the user calls the fire department. As another example, for an equipment failure, the SOP may recommend one or more corrective actions to perform to reset, restart, and/or reboot a piece of equipment associated with the equipment failure. In some embodiments, the automated resolution may be displayed on a graphical user interface (GUI). For example, the automated resolution may be displayed on a user device to notify the user as to what the resolution is.

In some embodiments, the automated resolution includes operation of the building equipment 1160. The automated resolution may include an adjustment of the building equipment 1160 based on the potential cause of the occurrence of the event. For example, if the potential cause of the occurrence of the event is flooding, the automated resolution may include disabling water pipes that provide water to that part of the building. Several additional examples of automated resolutions or interventions which can be performed by the integration system 1105 are described in detail in U.S. patent application Ser. No. 18/633,097 filed Apr. 11, 2024, the entire disclosure of which is incorporated by reference herein.

The interface generator 1145 may generate an interface. In some embodiments, the interface may be a user interface displayed via a user device (e.g., user device 1165). The interface generator 1145 may generate a user interface that may contain at least one of various components of and/or may perform similar functionality to that of any of the user interfaces described herein (e.g., user interface 508, user interface 1200, user interface 1400, user interface 1500, user interface 1600, and/or user interface 1700). In some embodiments, the interface generator 1145 may retrieve information from one or more components of the integration system 1105 (e.g., event detector 1125, device identifier 1130, time detector 1135, data retriever 1140, etc.). For example, the interface generator 1145 may be configured to generate a user interface illustrating data relating to one or more faults detected by the event detector 1125 and/or data from one or more proximate video devices (e.g., video device 1170) identified by device identifier 1130.

In some embodiments, the interface generator 1145 may generate a user interface that includes a graphical representation of a building and/or an alert to indicate detection of a fault condition. For example, the interface generator 1145 may generate a user interface that include an image and/or a 3D display of the building (e.g., a graphical representation), and an icon (e.g., an alert) that corresponds to fault conditions. In some embodiments, the alert may include a selectable element. For example, the alert may include a button, a toggle, a switch, etc. In some embodiments, the interface generator 1145 may provide the user interface to the network interface 1150.

In some embodiments, the network interface 1150 may provide the user interface to the user device 1165. For example, the network interface 1150 may provide the user interface via the network 1155. In some embodiments, the network interface 1150 providing the user interface may cause the user device 1165 to display the user interface. For example, the user device 1165 may display the user interface via a screen (e.g., a display device).

In some embodiments, an operator and/or a user of the display device may select the selectable element. For example, the display device may include a touchscreen and the user select the selectable element by touching and/or interacting with a given portion of the touchscreen.

In some embodiments, the interface generator 1145 may receive, via the network interface 1150, an indication that the user selected the selectable element. In some embodiments, the interface generator 1145 may update the user interface. For example, the interface generator 1145 may update the user interface responsive to selection of the selectable element. In some embodiments, the interface generator 1145 may update the user interface to include and/or display data captured by the video device. For example, the interface generator 1145 may update the user interface to include a video and/or images captured by the video devices 1170. In some embodiments, the data may be captured by the video device 1170 that was identified by the device identifier 1130.

In some embodiments, the user interface, generated by the interface generator 1145, may include one or more selectable elements. For example, the user interface may include a first selectable element to view data captured by the video devices 1170. As another example, the user interface may include a selectable element to adjust a time segment associated with the data captured by the video devices 1170.

In some embodiments, the network interface 1150 may communicate data from one or more components of the system 1100 to the integration system 1105. In some embodiments, the network interface 1150 may contain one or more similar components and/or may perform similar functionality to that of the data communications interface 804. In some embodiments, the integration system 1105 may access, via the network interface 1150, data relating to building equipment 1160. In some embodiments, the network interface 1150 may communicate data relating to building equipment 1160 to the event detector 1125 and the event detector 1125 can detect one or more fault conditions of the building equipment 1160.

### User Interfaces

As described herein, the integration system 1105 and/or a component thereof may generate, update, display, provide, and/or otherwise present at least one user interface. In some embodiments, the integration system 1105 may generate the various user interface described herein. In some embodiments, the various user interfaces described herein may be modified, adjusted, updated, changed, and/or otherwise modified. For example, a first user interface may be updated to include a second user interface. As another example, a second user interface may be provided as a pop of window on top of and/or over a first user interface. In some embodiments, information that is shown with respect to a first user interface may also be shown with respect to a second user interface. In some embodiments, a first user interface and a second user interface may be combined and/or provide with one another.

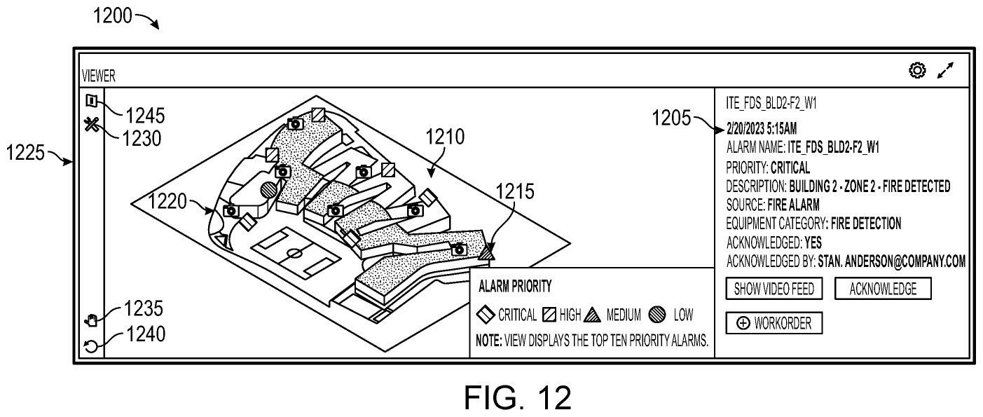

FIG. 12 depicts a user interface 1200. The user interface 1200 may comprise a building map 1210 (e.g., a 3-dimensional facility schematic, a 3D graphical display, a graphical representation, a rendering, etc.). In some embodiments, the building map 1210 may refer to and/or include the graphical representation of the building described herein. In some embodiments, the building map may include one or more indications of an activated alarm 1215 within the building. For example, the activated alarm 1215 may indicate a detected fault. In some embodiments, the indications of the activated alarms 1215 may refer to and/or include an alert to indicate a fault condition. Additionally and/or alternatively, the building map 1210 may include indications of one or more events and/or occurrences of events.

In some embodiments, the one or more indications may be designated by a particular color (e.g., red, orange, yellow, etc.) and/or a particular shape (e.g., diamond, square, triangle, circle, etc.). The particular color and/or the particular shape of the indication may correspond to an alarm priority (e.g., a severity of the fault). The alarm priority may be labeled as critical, high, medium, low, etc. depending on a risk evaluation of the alarm (e.g., a fire alarm may have a particular color and/or shape that corresponds to a critical severity, while an alarm associated with the performance of an AHU may have a particular color and/or shape that corresponds to a medium severity). In some embodiments, the one or more indications of the activated alarm 1215 on the user interface 1200 may be and/or include a selectable element. In some embodiments, selection of the selectable element may provide information relating to that alarm. For example, if a user selects any one of the one or more indications of an activated alarm 1215 on the user interface 1200, a panel (e.g., side panel 1205) may be generated, updated, and/or displayed to present the information relating to that alarm (e.g., the detected fault) and/or events.

The user interface 1200 may also illustrate one or more video devices (e.g., cameras) located across the building map. The one or more video devices may include the video devices 1170. For example, each of the indications of the activated alarm may be proximate to an icon (e.g., a camera icon 1220) identifying the video device (e.g., camera) nearest to the location of the activated alarm 1215. As another example, each camera icon 1220 may represent and/or indicated video devices that are within a predetermined threshold distance (e.g., 100 feet, 10 feet, 5 feet, etc.) to the location of the event.

In some embodiments, the one or more camera icons 1220 may be a selectable element of the user interface 1200. Engaging with the selectable element may allow a user to access video data corresponding to the video device represented by the camera icon. For example, the video data may comprise a live video stream or a recorded feed from the corresponding video device. The recorded feed may correspond to a time segment (e.g., one or more of the time intervals detected and/or determined by the time detector 1135) including the point in time when the alarm was activated (e.g., when the fault was detected by the event detector 1125).

In some embodiments, the user interface 1200 may include a tool bar 1225 with additional selectable elements. For example, the tool bar may include a settings icon 1230 (e.g., a gear icon, a wrench icon, etc.), a help icon 1235 (e.g., a question mark, a hand icon, etc.,), a refresh icon 1240, and/or a map icon 1245. In some embodiments, the settings icon 1230 may be configured to allow the user to customize preferences relating to the display on the user interface 1200. In some embodiments, the help icon 1235 may be configured to present an array of frequently asked questions (FAQs), a search bar, a chat function, etc. In some embodiments, the refresh icon 1240 may be configured to allow a user to update the display to reflect any changes in a status of one or more of the alarms (e.g., additional alarms have been activated, one or more of the alarms have been deactivated, etc.). In some embodiments, the map icon 1245 may be configured to generate and illustrate the building map 1210 on a display where the building map 1210 may not otherwise be presented.

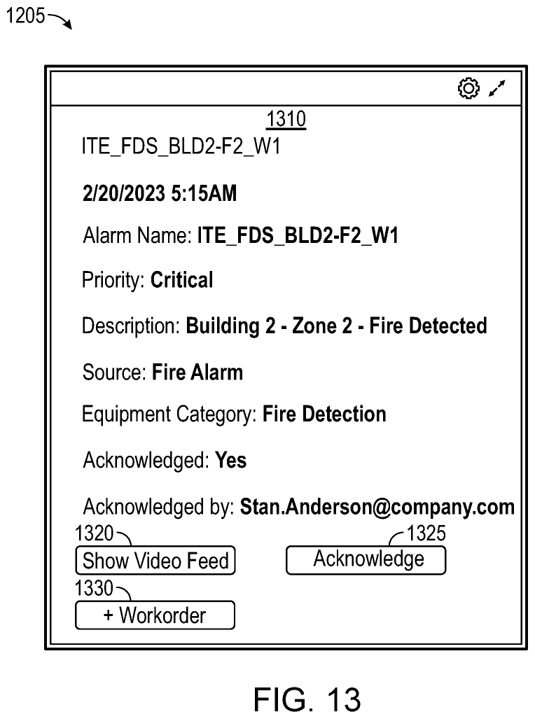

FIG. 13 shows a detailed view of the side panel 1205 of the user interface 1200. The side panel 1205 may display information 1310 related to one or more of the activated alarms (e.g., activated alarm 1215) when a user interacts with the indication of that alarm on the building map 1210. For example, the information 1310 of the side panel 1205 may comprise a title for the alarm (e.g., alarm name), a date and time of activation of the alarm, a priority of the alarm (e.g., critical, high, medium, low, etc.), a description (e.g., building 2, zone 2, fire detected, etc.), a source (e.g., fire alarm), an equipment category (e.g., fire detection), an acknowledgement of activation of the alarm (e.g., yes or no), and an individual who acknowledged the activation of the alarm (e.g., the company email of a technician who first acknowledged the activated alarm).

The side panel 1205 may also include selectable elements that indicate one or more actions that the user can take in response to detecting the activated alarm. For example, the user can navigate to a video output 1320 (e.g., a live stream, a recorded feed, etc.) of the video device (e.g., video device 1170) nearest to the location of the activated alarm 1215 (e.g., via a “Show Video Feed” widget). As another example, the user can acknowledge the activation of the alarm 1325 (e.g., via an “Acknowledge” widget). As another example, the user can submit a request for a work order 1330 to address the fault indicated by the activated alarm (e.g., via a “Workorder” widget). In some embodiments, the side panel 1205 may comprise a pop-up window (e.g., the side panel 1205 may be generated and presented via the user interface 1200 when the user selects one of the one or more indications of the activated alarm on the building map of the user interface 1200).

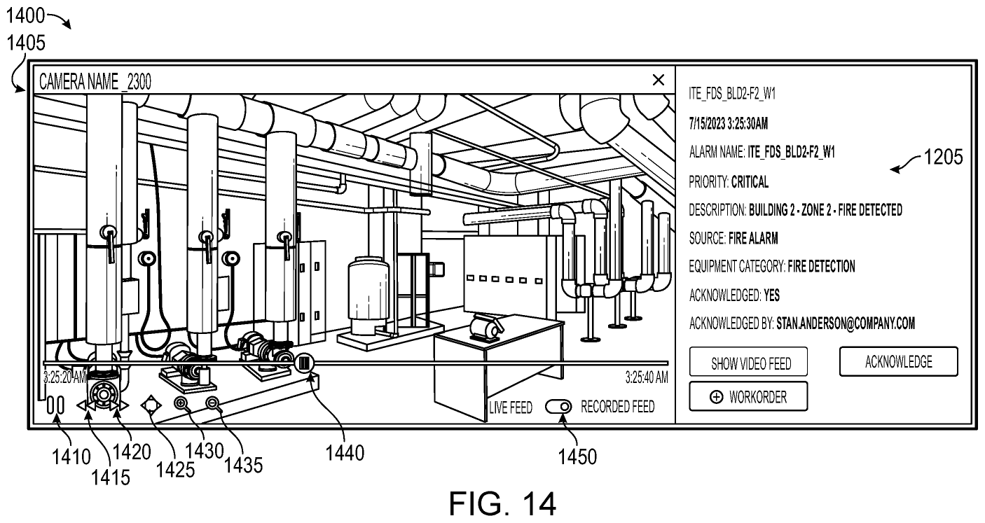

FIG. 14 depicts a user interface 1400. The user interface 1400 may include some and/or all of the elements of the user interface 1200. In some embodiments, the user interface 1400 may display a video recording 1405 (e.g., a recorded feed) of a video device (e.g., video device 1170) proximate to an activated alarm and/or an occurrence of an event. For example, the user interface 1400 may be the display that is generated in response to a user selecting the video output 1320 (e.g., “Show Video Feed” widget) of the side panel 1205.

In some embodiments, the video recording may be automatically generated to cover a time segment (e.g., one or more of the time intervals detected by the time detector 1135) during which that alarm was activated (e.g., when the fault was detected by the event detector 1125). For example, the video recording 1405 may cover a ten second period prior to the time of alarm activation and a ten second period following the time of alarm activation. In some embodiments, the time segment of the video recording may be customizable depending on a user's preferences. For example, the video recording 1405 may cover a 20 second period prior to the time of alarm activation and a 20 second period following the time of alarm activation. The display of the video recording 1405 may also include a name of the video device that captured the video recording (e.g., Camera No. 34). The user interface 1400 may also include side panel 1205 to display information 1310 related to one or more of the activated alarms associated with the video recording 1405.

In some embodiments, the user interface 1400 may include one or more selectable elements to allow a user to interact with the video recording 1405. For example, one selectable element may allow the user to pause and/or resume the video recording 1405 (e.g., play/pause button 1410), another selective element may allow the user to rewind 1415 the video recording 1405 (e.g., rewind the video by two-second intervals), another selective element may allow the user to fast forward 1420 through the video recording 1405 (e.g., fast forward through the video at two-second intervals), another selective element may allow the user to zoom in 1430 on a particular feature of the video recording 1405, another selective element may allow the user to zoom out 1435 on the video recording 1405, another selective element may allow a user to return to an original orientation 1425 of the video recording 1405 based on the orientation of the video device, etc. In some embodiments, the user interface 1400 includes a selectable element (e.g., a toggle 1450) configured to allow a user to switch between the video recording 1405 from the video device and a live video stream of the video device. In some embodiments, the user interface 1400 includes a selectable element (e.g., a scroll bar 1440) configured to allow a user to move through the video at intervals of the user's choice.

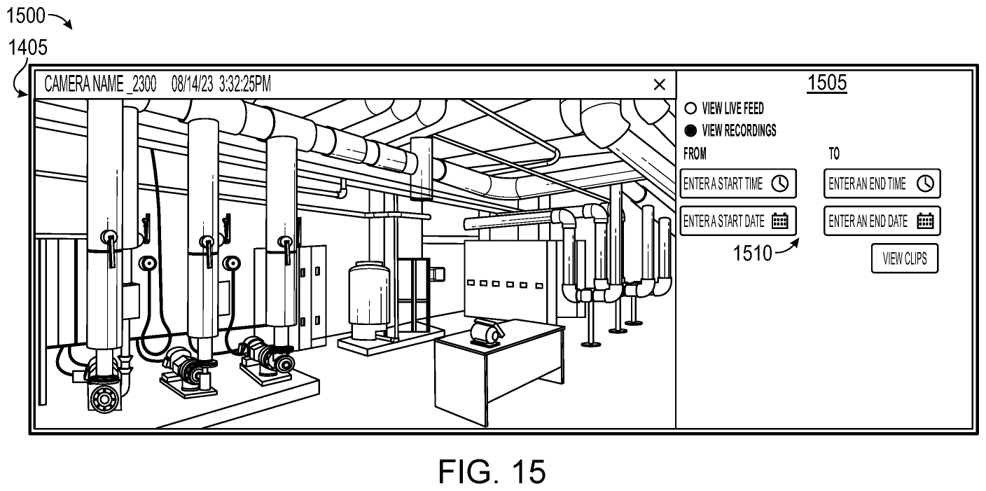

FIG. 15 depicts a user interface 1500, according to some embodiments. The user interface 1500 may include some or all of the elements of user interface 1200 and/or user interface 1400. In some embodiments, the user interface 1500 may include a display of visual output (e.g., a video recording 1405, an image, a live stream, etc.) from a video device (e.g., video device 1170). In some embodiments, the user interface 1500 may include a side panel 1505 configured to allow the user to specify a time segment and/or a date range 1510 over which the video recording 1405 may cover. For example, the user may request to view a series of video recordings 1405 from video device 1170 between 3:32:15 PM and 3:32:35 PM for an entire week and/or each day of the week. The user interface 1500 may, responsive to the user request, prompt the system 1100 to generate the clips corresponding to the user's request. The user interface 1500 may also include a selectable element configured to allow the user to navigate between a display of a video recording 1405 and a live stream from the video device 1170 (e.g., the toggle 1450).

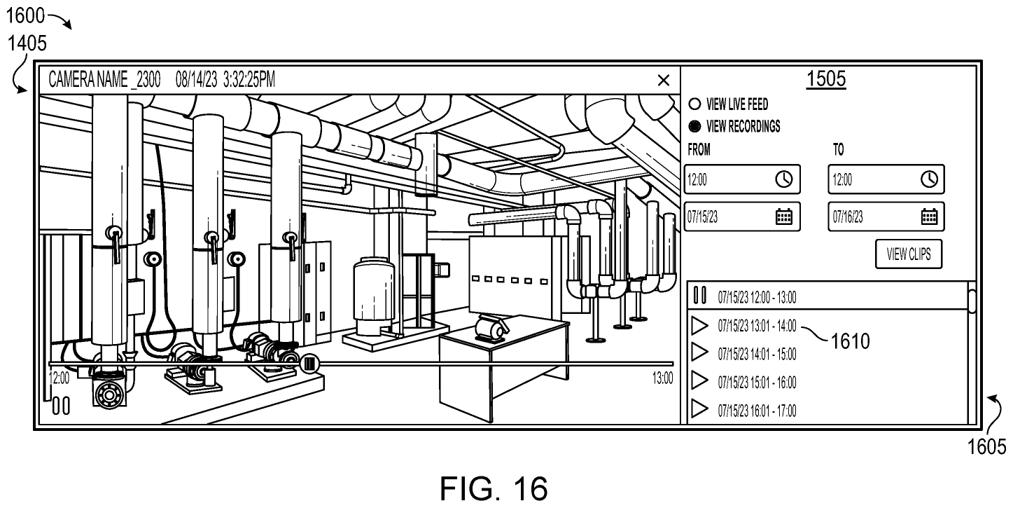

FIG. 16 depicts a user interface 1600. The user interface 1600 may include some or all of the elements of user interface 1200, the user interface 1400, and/or the user interface 1500. In some embodiments, the user interface 1600 may display the generated response 1605 to the user request submitted via the user interface 1500 for a series of video recordings 1610 for a specified time segment over a specified date range. For example, the user interface 1600 may display an array (e.g., a list view) of the seven video recordings (e.g., clips) from the video device 1170 between 3:32:15 PM and 3:32:35 PM on each of the selected days. In some embodiments, each of the seven clips may include a title bar indicating the date and time of the video recording being shown on the user interface 1600.

In some embodiments, the user interface 1600 may include a series of video recordings 1610 of a specified duration spanning the entirety of a specified time interval. For example, a user may request to view video recordings from 12:00:00 AM on a first day, until 12:00:00 AM on a second day. The user interface 1600 may be configured to display an array (e.g., a list) of video recordings capturing the video footage of video device 1170 over the entire timespan from 12:00:00 AM on Jul. 15, 2023, until 12:00:00 AM on Jul. 16, 2023. In some embodiments, each of the video recordings comprise a specified duration (e.g., 59 minutes 15 minutes, 120 minutes, etc.). In some embodiments, the user interface 1600 may include the side panel 1505. The side panel 1505 may include a selectable element configured to allow a user to switch between a video recording of the video device and a live stream from the video device.

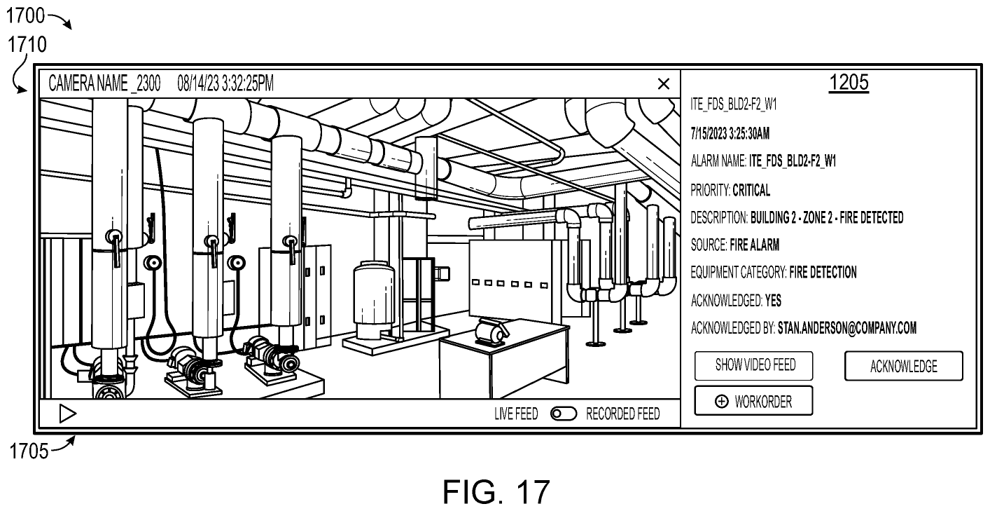

FIG. 17 depicts a user interface 1700, according to some embodiments. The user interface 1700 may include some or all of the elements of the user interface 1200, the user interface 1400, the user interface 1500, and/or the user interface 1600. In some embodiments, the user interface 1700 may display a live video output 1710 (e.g., a live stream, a live feed, etc.) of a video device (e.g., video device 1170). For example, user interface 1700 may be generated and presented via a user device (e.g., user device 1165) in response to a user interacting with one of the one or more selectable elements (e.g., one of the one or more indications of an activated alarm and/or one of the one or more camera icons) of the building map of user interface 1200. In some embodiments, the user interface 1700 may be configured to display a side panel (e.g., side panel 1205) including information related to the activated alarm featured in the live video output 1710.

In some embodiments, the user interface 1700 may comprise a selectable element (e.g., a toggle) configured to allow the user to switch between the live video output 1710 and a recorded feed from video device 1170 (e.g., the toggle 1450, a button). In some embodiments, the user interface 1700 may be configured to allow the user to pause the live video output, of the video device 1170 through a selectable element 1705 on the display. For example, the user can pause the live stream at a particular moment in time and then resume the live stream, wherein resuming the live stream may cause the live video output, of the video device 1170, to return to the real-time video footage from the video device.

FIG. 18 depicts a user interface 1800, according to some embodiments. The user interface 1800 may include some or all of the elements of the user interface 1200, the user interface 1400, the user interface 1500, and/or the user interface 1600. In some embodiments, the user interface 1800 may display a graphical representation of a building (e.g., digital twin). In some embodiments, the user interface 1800 may display a video device 1830 (e.g., an icon corresponding to the video device 1170). For example, user interface 1800 may be generated and presented via a user device (e.g., user device 1165) in response to a user interacting with the one or more selectable elements (e.g., selecting a general area of the building to examine more closely) of the graphical representation of the building.

In some embodiments, the user interface 1800 may be configured to display a first side panel 1805 including information related to video devices displayed on the graphical representation. For example, the first side panel 1805 may include a selectable element configured to display operations data 1815 for the video device 1830 and/or building equipment. As another example, the first side panel 1805 may include a selectable element configured to allow the user to command and control 1820 the video device 1830 and/or building equipment. As another example, the first side panel 1805 may include a selectable element configured to allow the user to access video feed 1825 (e.g., live video feed, recorded video feed). In some embodiments, the user interface 1800 may include a selectable element (e.g., the toggle 1450) configured to allow the user to switch between information related to the live video output and a recorded feed from video device 1170.

In some embodiments, the user interface 1800 may include a first selectable element 1835 configured to clear a user input relating to desired video recordings. In some embodiments, the user interface 1800 may include a second selectable element 1840 configured to apply a user input relating to desired video recordings. The user interface 1800 may include a second side panel 1810 including information related to building equipment (e.g., building equipment 1160). For example, the user can select a specific part of the building (e.g., zone, floor, room, etc.) and view a list of all of the building equipment located in that part of the building.

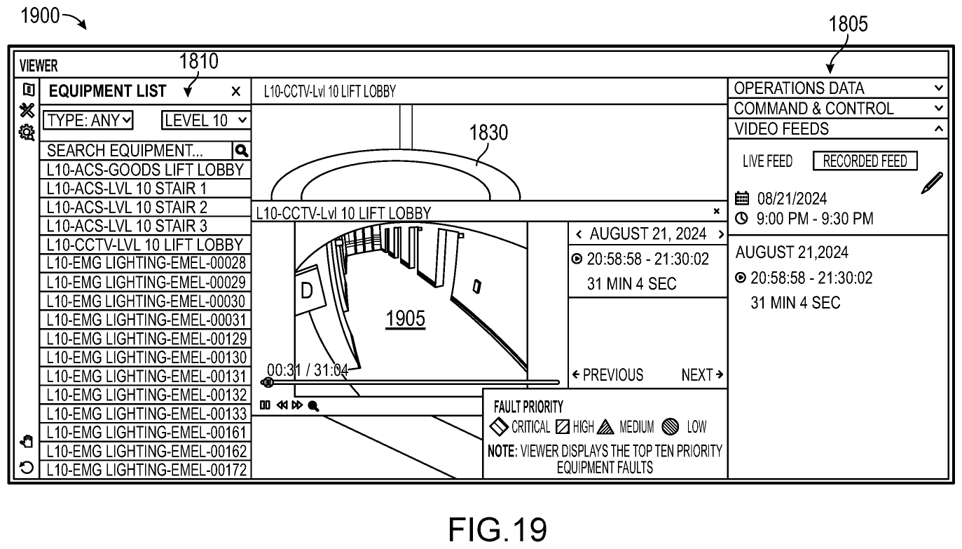

FIG. 19 depicts a user interface 1900, according to some embodiments. The user interface 1900 may include some or all of the elements of the user interface 1200, the user interface 1400, the user interface 1500, the user interface 1600, and/or the user interface 1800. In some embodiments, the user interface 1900 may display live video feed and/or recorded video feed 1905 corresponding to the video device 1830 (e.g., video device 1170) of a graphical representation (e.g., digital twin) of a building. For example, user interface 1900 may be generated and presented via a user device (e.g., user device 1165) in response to a user interacting with the one or more selectable elements (e.g., selecting a camera of the graphical representation) of the graphical representation of the building. The user interface 1900 may display the side panel 1805 including information relating to any of the live video feed and/or recorded video feed, command and control information, and operations data. The user interface 1900 may include the side panel 1810 to display building equipment information.

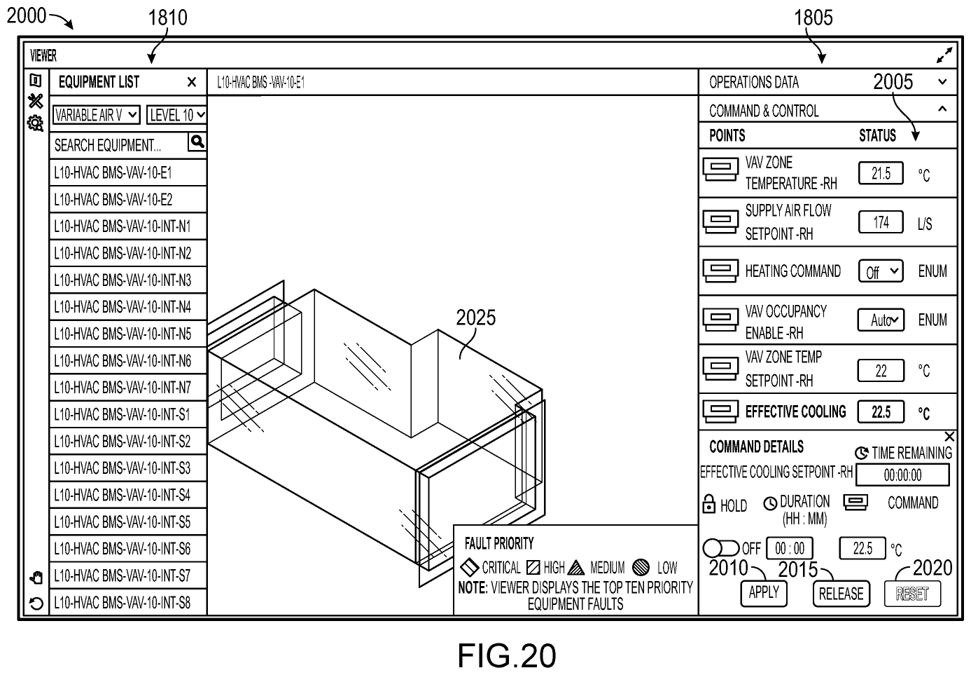

FIG. 20 depicts a user interface 2000, according to some embodiments. The user interface 2000 may include some or all of the elements of the user interface 1200, the user interface 1400, the user interface 1500, the user interface 1600, the user interface 1800, and/or the user interface 1900. In some embodiments, the user interface 2000 may display a graphical representation of one or more pieces of building equipment 2025 (e.g., building equipment 1160). For example, user interface 1900 may be generated and presented via a user device (e.g., user device 1165) in response to a user interacting with the one or more selectable elements (e.g., selecting a piece of building equipment) of the graphical representation of the building. In some embodiments, the graphical representation of the building equipment 2025 may display an approximate location of a detected event. For example, if the building equipment is a vent, and a damper of the vent is closed when it should be open, the graphical representation of the vent may highlight the damper, indicating that the event relates to the damper. The user interface 2000 may display a first side panel (e.g., side panel 1810) displaying information about building equipment.

In some embodiments, the user interface 2000 may display the side panel 1805. The side panel 1805 may display information regarding the building equipment. For example, the second side panel may display information relating to temperature and air flow of a vent. In some embodiments, the side panel 1805 may display input fields corresponding to commands 2005 for the building equipment 2025. For example, side panel 1805 may allow a user to input a temperature command 2005 to adjust the temperature in the environment of the building equipment 2025. The commands 2005 for building equipment 2025 may include one or more selectable elements configured to impact the operations of the building equipment 2025. For example, a first selectable element 2010 may be configured to apply user inputs into commands for building equipment 2025. As another example, a second selectable element 2015 may be configured to release or terminate a user input command. As another example, a third selectable element 2020 may be configured to return the building equipment 2025 settings to default settings.

Referring generally to the user interfaces described herein, in some embodiments, at least one user interface may be generated such that a list of all alarms may be presented as part of a diagnostic workflow trigged by various events. The user interface may include selectable elements corresponding to different functions of the diagnostic workflow. As a non-limiting example, selectable elements may allow the user to acknowledge alarms, generate work orders to fix issues associated with the alarms, command and/or control building equipment, and view a standard operating procedure based on events associated with the alarms. The selectable elements may be presented on the user interface in different configurations. For example, the selectable elements may be separate subtabs of a tab of the user interface. As another example, the selectable elements may be disposed in a single window. Having some or all these features of a diagnostic workflow included within a single user interface can lead to improved user interaction with graphical user interfaces of building automation systems. For example, the user may benefit from acknowledging an event and submitting a work order from the same user interface.

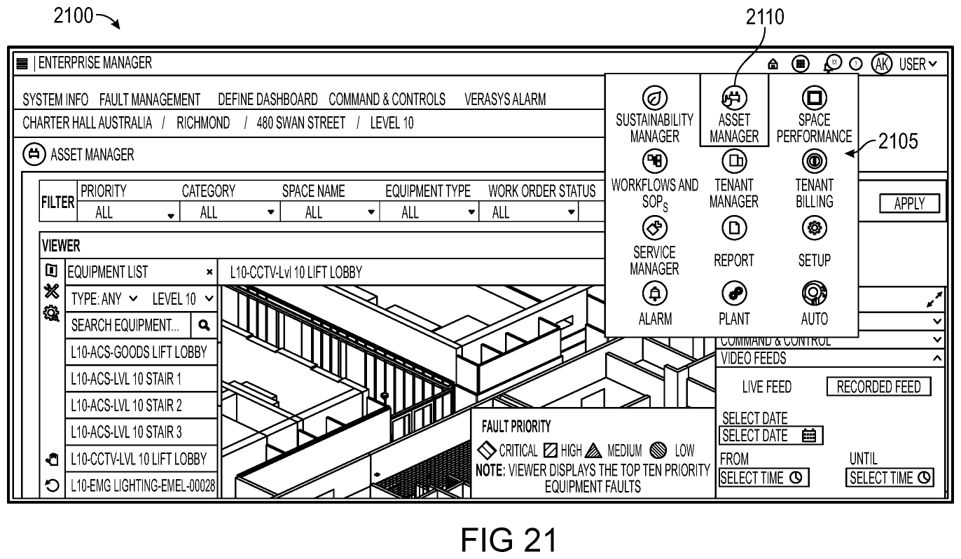

FIG. 21 depicts a user interface 2100, according to some embodiments. The user interface 2100 may include some or all of the elements of the user interface 1200, the user interface 1400, the user interface 1500, the user interface 1600, the user interface 1800, the user interface 1900, and/or the user interface 2000. In some embodiments, the user interface 2100 includes an application manager 2105, the application manager configured to switch between one or more applications of the user interface. For example, one application of the application manager 2105 may be directed to the graphical representation of the building, and another application of the application manager may be directed to submitting service requests for the building. The application manager 2105 may allow a user to switch between applications within the same user interface. In some embodiments, the application manager 2105 may include one or more selectable elements 2110 (e.g., icons) corresponding to applications of the application manager 2105. For example, the user can select an icon labeled “Asset Manager” to navigate to the asset manager page of the user interface 2100.

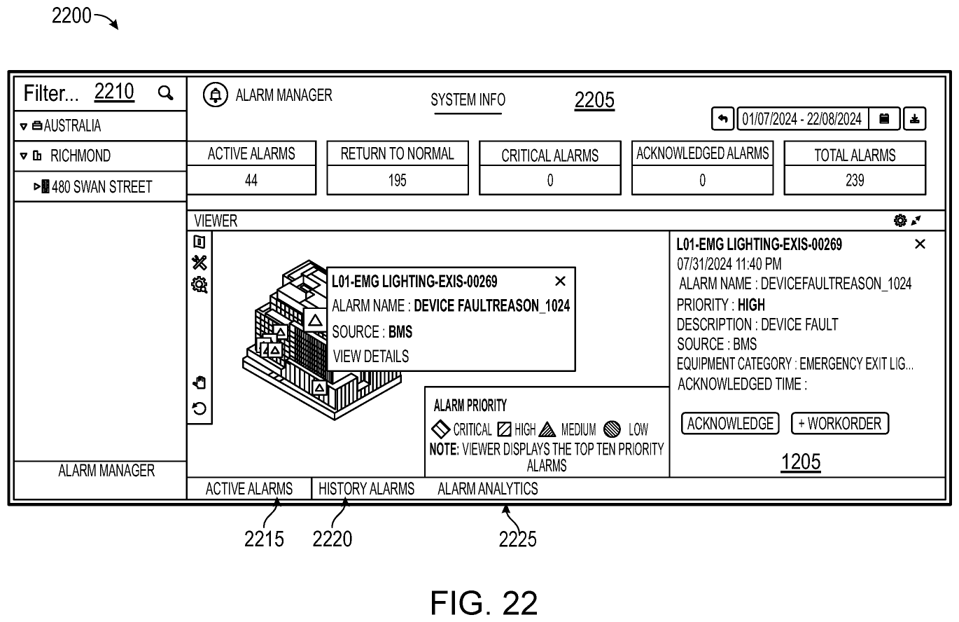

FIG. 22 depicts a user interface 2200, according to some embodiments. The user interface 2200 may include some or all of the elements of the user interface 1200, the user interface 1400, the user interface 1500, the user interface 1600, the user interface 1800, the user interface 1900, the user interface 2000, and/or the user interface 2100. In some embodiments, the user interface 2200 includes a graphical representation (e.g., digital twin, a BIM, a digital representation, etc.) of a building. For example, the user interface 2200 may include a graphical representation of the building with alarm notifications disposed in locations of the graphical representation corresponding to locations of the building where events (e.g., an event within the building) have been detected (e.g., by the event detector 1125). The alarm notifications may be based upon an assigned priority of the alarms. For example, an alarm with a critical priority may have an icon that differs from an alarm with a low priority.

In some embodiments, the user interface 2200 includes a top panel 2205 including alarm data for the building. For example, the top panel 2205 may include information regarding any of the number of active alarms, formerly active alarms, critical alarms, acknowledged alarms, and total alarms. The top panel 2205 may include other alarm information as well. In some embodiments, the user interface 2200 may include a side panel 2210 including building information for one or more buildings. For example, the side panel 2210 may include one or more selectable elements that correspond to clients, cities, and/or individual buildings. The user may be able to select the one or more selectable elements to view alarm data for the selectable elements. In some embodiments, the user interface 2200 may include the side panel 1205. In some embodiments, the user interface 2200 may include a lower panel including active alarm data 2215 and historical alarm data 2220. The lower panel may include alarm analytics.

In some embodiments, the user interface 1200, the user interface 1400, the user interface 1500, the user interface 1600, the user interface 1700, the user interface 1800, the user interface 1900, the user interface 2000, the user interface 2100, and/or the user interface 2200 may fit a display (e.g., a screen) of a user device (e.g., the user device 1165). For example, the interface generator 1145 may generate any of the user interface 1200, the user interface 1400, the user interface 1500, the user interface 1600, the user interface 1700, the user interface 1800, the user interface 1900, the user interface 2000, the user interface 2100, and/or the user interface 2200. In some embodiments, the integration system 1105 may communicate an interface generated by the interface generator 1145 to the user device 1165 via a network 1155.

In some embodiments, at least one of the user interface 1200, the user interface 1400, the user interface 1550, the user interface 1600, the user interface 1700, the user interface 1800, the user interface 1900, the user interface 2000, the user interface 2100, and/or the user interface 2200 may include and/or present the various information generated, analyzed, and/or provided by the integration system 1005. In some embodiments, at least one of the user interface 1200, the user interface 1400, the user interface 1550, the user interface 1600, the user interface 1700, the user interface 1800, the user interface 1900, the user interface 2000, the user interface 2100, and/or the user interface 2200 may include the various types of information described herein.

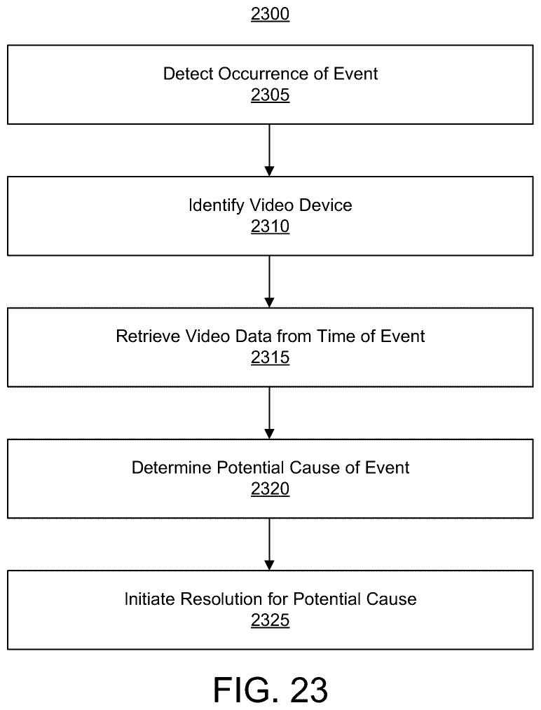

FIG. 23 depicts a flow diagram of a method 2300 for automatic responses to occurrences of events. In some embodiments, at least one system, device, and/or component described herein may perform the method 2300 and/or one or more steps thereof. For example, the integration system 1105 may perform the method 2300. In some embodiments, the method 2300 may modified and/or changed such that one or more steps of the method 2300 may be removed, combined, separated, omitted, skipped, repeated, replicated, reproduced, and/or otherwise altered. For example, a first step and a second step of the method 2300 may be combined into a single step. As another example, a given step of the method 2300 may be separated into multiple steps.

In some embodiments, at step 2305, an occurrence of an event may be detected. For example, the integration system 1105 may detect an event. At step 2305, a time of the occurrence of the event may be determined. For example, one or more processors of a Building Automation System (BAS) may detect an occurrence of an event associated with building equipment of a building and determine a time of the occurrence of the event. As another example, the event detector 1125 may detect the occurrence of the event, and the time detector 1135 may detect the time of the event. The event may be a fault event and/or a user selected event.

At step 2310, a video device may be identified. In some embodiments, the one or more processors of the BAS may identify a video device associated with the building equipment based on a building model of the building. For example, the device identifier 1130 may identify the video device 1170 associated with the building equipment 1160. The building model may include a Building Information Model (BIM) of the building. For example, the building model may include the BIM 1180. The BIM may indicate a location of the building equipment and a location of the video device. The video device may be associated with the building equipment based on a proximity to the building equipment and/or the video device ability to view the building equipment. For example, the BIM 1180 may indicate that the video device 1170 is positioned in the same room as the building equipment 1160. In another example the BIM 1180 may indicate that the video device 1170 is positioned to view the building equipment 1160.

At step 2315, video data from the time of the event may be retrieved. In some embodiments, one or more processors of a BAS may retrieve video data captured by the video device during a time segment including the time of the occurrence of the event. The video device may be a video device associated with the building equipment. In some embodiments, the time segment may be a user specified amount of time. For example, a user can select to retrieve video data for a time segment spanning from a minute before the occurrence of the event until a minute after the occurrence of the event. In some embodiments, the time segment can automatically be determined by the BAS. For example, the BAS may have a setting to automatically select a time segment spanning from five minutes before the occurrence of the event to three minutes after the occurrence of the event.

At step 2320, a potential cause of the occurrence of the event may be determined. In some embodiments, the one or more processors of the BAS may perform a diagnostic process using video data to determine the potential cause of the occurrence of the event. In some embodiments, the video data may be retrieved by the data retriever 1140. In some embodiments, the diagnostic process includes referencing the video data to a stored list of potential cause for the event. For example, if the video data indicates that there is a fire, and the list of potential causes includes a gas fire, electrical fire, flood, and chemical leak, the BAS may filter out flood and chemical leak as potential causes.

In some embodiments, the diagnostic process may include using the video data as an input to a machine learning model configured to detect objects and/or events occurring in the video data. For example, if the video data indicates that there is a fire, and that the piece of equipment in the video data is a generator, the machine learning model 1175 may determine that a generator fire is a potential cause of the event.

In some embodiments, the diagnostic process of the BAS may include asking the user questions based on the video data. For example, if the video data indicates that there is flooding in a bathroom of a building, the BAS may ask the user about the history of plumbing maintenance in the building. Based on the response from the user, the BAS may determine that a pipe bursting is a potential cause of the event. In some embodiments, the interface generator 1145 may generate an interface to be displayed on the user device 1165 to ask the user questions.

At step 2325, a resolution for the potential cause of the occurrence of the event may be initiated. In some embodiments, the one or more processors of the BAS may initiate an automatic resolution to address the potential cause of the occurrence of the event. The automated resolution may be based on the filtered list of potential causes. In some embodiments, the automated resolution may be based on the machine learning model 1175 determination of a potential cause of the event. In some embodiments, the automated resolution may be based on user responses to questions from the BAS based on the video data. In some embodiments, the automated resolution may be displayed on a graphical user interface (GUI). For example, the automated resolution may be displayed on the user device 1165 to notify the user as to what the resolution is.

In some embodiments, the automated resolution includes operation of the building equipment 1160. The automated resolution may include an adjustment of the building equipment 1160 based on the potential cause of the occurrence of the event. For example, if the potential cause of the occurrence of the event is flooding, the automated resolution may include disabling water pipes that provide water to that part of the building. In some embodiments, the automated resolution may include proving a recommendation to the user on how to address the event. In some embodiments, the recommendation may be based on a standard operating procedure (SOP) stored by the processing circuit 1110. For example, for a fire, the SOP may recommend that the user calls the fire department.

In some embodiments, method 2300 may include a generation of a graphical user interface comprising a graphical representation of the building including the building equipment 1160 and the video device 1170. The generated graphical user interface may display the video data responsive to selection of the video device in the graphical representation of the building. The graphical user interface may display a message including the initiated resolution of the occurrence of the event. For example, the message may provide a recommendation to address the potential cause of the occurrence of the event. In some embodiments, the generated graphical user interface may be displayed on the user device 1165.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The background section is intended to provide a background or context to the invention recited in the claims. The description in the background section may include concepts that could be pursued, but are not necessarily ones that have been previously conceived or pursued. Therefore, unless otherwise indicated herein, what is described in the background section is not prior art to the present invention and is not admitted to be prior art by inclusion in the background section.

What is claimed is:

1. A Building Automation System (BAS) comprising one or more memory devices storing instructions thereon that, when executed by one or more processors, cause the one or more processors to:
detect an occurrence of an event associated with building equipment of a building and determine a time of the occurrence of the event;
in response to detecting the occurrence of the event, execute an automated video gathering process comprising:
identifying a video device associated with the building equipment based on a building model of the building; and
retrieving video data captured by the video device during a time segment comprising the time of the occurrence of the event;
perform a diagnostic process using the video data to determine a potential cause of the occurrence of the event; and
initiate an automated resolution to address the potential cause of the occurrence of the event.

2. The BAS of claim 1, wherein the instructions cause the one or more processors to:
generate a graphical user interface comprising a graphical representation of the building including the building equipment and the video device; and
present the video data via the graphical user interface responsive to selection of the video device in the graphical representation of the building.

3. The BAS of claim 1, wherein the automated resolution comprises an adjustment of an operation of the building equipment, the adjustment being based on the potential cause of the occurrence of the event.

4. The BAS of claim 1, wherein the instructions cause the one or more processors to:
provide a recommendation, via a graphical user interface, to address the potential cause of the occurrence of the event.

5. The BAS of claim 1, wherein the building model includes a Building Information Model (BIM) of the building, the BIM indicating a location of the building equipment and a location of the video device, and wherein the instructions cause the one or more processors to:
determine, based on the BIM, that the video device is positioned to view the building equipment; and
identify the video device as being associated with the building equipment responsive to determining that the video device is positioned to view the building equipment.

6. The BAS of claim 1, wherein the instructions cause the one or more processors to:
display, via a graphical user interface, a standard operating procedure (SOP), the SOP including one or more predetermined actions executable to address the potential cause of the occurrence of the event.

7. The BAS of claim 1, wherein the video data is sourced from at least one of a live stream of a video output captured by the video device or a recording of a video output corresponding to the time.

8. The BAS of claim 1, wherein the instructions cause the one or more processors to:
determine a priority level associated with the occurrence of the event; and
display the occurrence of the event and the priority level via a graphical user interface.

9. The BAS of claim 1, wherein identifying the video device associated with the building equipment comprises:
determining, based on a Building Information Model (BIM) of the building, a room of the building in which the building equipment is located;
determining, based on the BIM, that the video device is located in the room of the building; and
identifying the video device as being associated with the building equipment responsive to determining that the video device is located in the room of the building.

10. The BAS of claim 1, wherein identifying the video device associated with the building equipment comprises:
determining, based on a digital twin of the building, a location of the building in which the building equipment is located;
determining, based on the digital twin, that the video device is (1) positioned within a predetermined threshold distance from the location of the building and (2) positioned to view the building equipment; and
identifying the video device as being associated with the building equipment.

11. A method, comprising:
detecting, by one or more processors of a Building Automation System (BAS), an occurrence of an event associated with building equipment of a building and determine a time of the occurrence of the event;
executing, by the one or more processors, an automated video gathering process comprising:
identifying a video device associated with the building equipment based on a building model of the building; and
retrieving video data captured by the video device during a time segment comprising the time of the occurrence of the event;
performing, by the one or more processors, a diagnostic process using the video data to determine a potential cause of the occurrence of the event; and
initiating, by the one or more processors, an automated resolution to address the potential cause of the occurrence of the event.

12. The method of claim 11, further comprising:
generating, by the one or more processors, a graphical user interface comprising a graphical representation of the building including the building equipment and the video device; and
presenting, the video data via the graphical user interface responsive to selection of the video device in the graphical representation of the building.

13. The method of claim 11, wherein the building model includes a Building Information Model (BIM) of the building, the BIM indicating a location of the building equipment and a location of the video device.

14. The method of claim 13, further comprising:
determining, based on the BIM, that the video device is positioned to view the building equipment; and
identifying the video device as being associated with the building equipment responsive to determining that the video device is positioned to view the building equipment.

15. The method of claim 11, wherein identifying the video device associated with the building equipment comprises:
determining, based on a Building Information Model (BIM) of the building, a room of the building in which the building equipment is located;
determining, based on the BIM, that the video device is located in the room of the building; and
identifying the video device as being associated with the building equipment responsive to determining that the video device is located in the room of the building.

16. The method of claim 11, further comprising:
displaying, via a graphical user interface, a standard operating procedure (SOP), the SOP including one or more predetermined actions that can be taken to address the potential cause of the occurrence of the event.

17. The method of claim 11, further comprising providing a recommendation, via a graphical user interface, to address the potential cause of the occurrence of the event.

18. One or more non-transitory storage media storing instructions thereon that, when executed by one or more processors, cause the one or more processors to perform operations comprising:
detecting an occurrence of an event associated with building equipment of a building and determine a time of the occurrence of the event;
executing an automated video gathering process comprising:
identifying a video device associated with the building equipment based on a building model of the building; and
retrieving video data captured by the video device during a time segment comprising the time of the occurrence of the event;
performing a diagnostic process using the video data to determine a potential cause of the occurrence of the event; and
initiating an automated resolution to address the potential cause of the occurrence of the event.

19. The one or more non-transitory storage media of claim 18, wherein the instructions cause the one or more processors to perform operations further comprising:
generating a graphical user interface comprising a graphical representation of the building including the building equipment and the video device; and
presenting the video data via the graphical user interface responsive to selection of the video device in the graphical representation of the building.

20. The one or more non-transitory storage media of claim 18, wherein the building model includes a Building Information Model (BIM) of the building, the BIM indicating a location of the building equipment and a location of the video device, and wherein the instructions cause the one or more processors to perform operations further comprising:
determining, based on the BIM, that the video device is positioned to view the building equipment; and
identifying the video device as being associated with the building equipment responsive to determining that the video device is positioned to view the building equipment.
